(19) United States
(12) Patent Application Publication
(10) Pub. No.: US 2025/0206355 A1
(43) Pub. Date: Jun. 26, 2025

(54) MOBILE OBJECT CONTROL DEVICE, MOBILE OBJECT CONTROL METHOD, AND MOBILE OBJECT

(71) Applicant: SONY SEMICONDUCTOR SOLUTIONS CORPORATION, KANAGAWA (JP)

(72) Inventor: EIJI OBA, KANAGAWA (JP)

(21) Appl. No.: 18/849,895

(22) PCT Filed: Mar. 15, 2024
(86) PCT No.: PCT/JP2023/010000

§ 371 Date: Sep. 23, 2024

(30) Foreign Application Priority Data
Mar. 31, 2022 (JP) 2022-058474

(51) Int. Cl. B60W 60/00; B60W 50/00; B60W 50/08; G06F 8/65

(52) U.S. Cl. CPC B60W 60/005; B60W 50/0098; B60W 50/08; B60W 60/001; G06F 8/65; B60W 2520/10; B60W 2554/802

(57) ABSTRACT

The present technology relates to a mobile object control device, a mobile object control method, and a mobile object that enable a user to appropriately take a necessary measure for a mobile object that performs automated driving. A mobile object control device includes: a travel environment condition acquisition unit that acquires a travel environment condition used to set an automated driving level of a mobile object; an action planning unit that creates a travel plan including a path and the automated driving level applied to each section on the path on the basis of the travel environment condition that has been acquired, and creates a measure-taking method for an automated driving restricted section being a section in which automated driving is restricted; and an output control unit that controls presentation of guidance information including the measure-taking method to a user, in which the action planning unit sets or changes the travel plan according to the measure-taking method selected by the user. The present technology can be applied to, for example, an automated vehicle.

### TECHNICAL FIELD

The present technology relates to a mobile object control device, a mobile object control method, and a mobile object, and more particularly, to a mobile object control device, a mobile object control method, and a mobile object that enable a user to appropriately take necessary measures for a mobile object that performs automated driving.

### BACKGROUND ART

In an automated driving level at level 3, a driver needs to return to manual driving in response to a request from a vehicle. With regard to this, conventionally, a technique for preventing a driver from excessively depending on the automated driving has been proposed (see, for example, Patent Document 1).

Furthermore, in the automated driving level at level 4, the use of automated driving is permitted within a range of an operational design domain (ODD) set at a vehicle design and development stage. Therefore, for example, in a case where the vehicle is traveling in the automated driving at level 4, when the traveling environmental condition changes and deviates from the range of the ODD, it is assumed that the automated driving at level 4 cannot be continued.

### CITATION LIST

### Patent Document

Patent Document 1: Japanese Patent Application Laid-Open No. 2021-193605

### SUMMARY OF THE INVENTION

### Problems to be Solved by the Invention

As described above, in the automated vehicle at the automated driving level at level 4 or lower, in a case where a situation occurs in which the automated driving at each level cannot be continued, there are cases where the driver is required to take a measure against the situation.

However, the ODD to be a section in which the automated driving can be used is not explicitly indicated, and the user cannot naturally recognize the ODD. Therefore, for example, in a case where the range of responsibility of the user to take over driving becomes ambiguous and an event occurs in which manual driving is originally expected, there is a risk that the driver cannot be sufficiently prepared within a limited time to cause an accident or a traffic jam.

The present technology has been made in view of such a situation, and an object thereof is to enable a user to appropriately take necessary measures for a mobile object that performs automated driving, such as an automated vehicle.

### Solutions to Problems

A mobile object control device according to a first aspect of the present technology includes: a travel environment condition acquisition unit that acquires a travel environment condition used to set an automated driving level of a mobile object; an action planning unit that creates a travel plan including a path and the automated driving level applied to each section on the path on the basis of the travel environment condition that has been acquired, and creates a measure-taking method for an automated driving restricted section being a section in which automated driving is restricted; and an output control unit that controls presentation of guidance information including the measure-taking method to a user, in which the action planning unit sets or changes the travel plan according to the measure-taking method selected by the user.

A mobile object control method according to the first aspect of the present technology acquires a travel environment condition used to set an automated driving level of a mobile object; creates a travel plan including a path and the automated driving level applied to each section on the path on the basis of the travel environment condition that has been acquired; creates a measure-taking method for an automated driving restricted section being a section in which automated driving is restricted; controls presentation of guidance information including the measure-taking method to a user; and sets or changes the travel plan according to the measure-taking method selected by the user.

A mobile object according to a second aspect of the present technology includes: a travel environment condition acquisition unit that acquires a travel environment condition used to set an automated driving level; an action planning unit that creates a travel plan including a path and the automated driving level applied to each section on the path on the basis of the travel environment condition that has been acquired, and creates a measure-taking method for an automated driving restricted section being a section in which automated driving is restricted; and an output unit that presents guidance information including the measure-taking method to a user, in which the action planning unit sets or changes the travel plan according to the measure-taking method selected by the user.

In the first aspect and the second aspect of the present technology, a travel environment condition used to set an automated driving level of a mobile object is acquired; a travel plan including a path and the automated driving level applied to each section on the path is created on the basis of the travel environment condition that has been acquired, and a measure-taking method for an automated driving restricted section being a section in which automated driving is restricted is created; guidance information including the measure-taking method is presented to a user; and the travel plan is set or changed according to the measure-taking method selected by the user.

### BRIEF DESCRIPTION OF DRAWINGS

FIG. 1 is a view illustrating an example of ranges of travel environment conditions.

FIG. 2 is a block diagram illustrating a configuration example of a vehicle control system to which the present technology is applied.

FIG. 3 is a block diagram illustrating a configuration example of an information processing unit.

FIG. 4 is a block diagram illustrating a configuration example of an output unit.

FIG. 5 is a view illustrating an example of sensing areas of a vehicle.

FIG. 6 is a diagram illustrating an example of a look up table (LUT).

FIG. 7 is a diagram illustrating an example of driving modes.

FIG. 8 is a diagram illustrating an example of a function of a control matrix.

FIG. 9 is a flowchart for explaining automated driving control processing.

FIG. 10 is a flowchart for explaining details of action planning processing.

FIG. 11 is a diagram for explaining a specific example of the action planning processing.

FIG. 12 is a diagram for explaining a specific example of the action planning processing.

FIG. 13 is a flowchart for explaining details of travel control processing.

FIG. 14 is a diagram illustrating an example of conventional guidance information.

FIG. 15 is a diagram for explaining a specific example of a selection menu.

FIG. 16 is a diagram for explaining a specific example of the selection menu.

FIG. 17 is a diagram for explaining a specific example of the selection menu.

FIG. 18 is a diagram for explaining the timing of presenting the selection menu.

FIG. 19 is a diagram illustrating an example of guidance information.

FIG. 20 is a flowchart for explaining details of post-travel processing.

FIG. 21 is a flowchart for explaining function update control processing.

FIG. 22 is a diagram illustrating a first example of a protection mechanism of a sensor.

FIG. 23 is a diagram illustrating the first example of the protection mechanism of the sensor.

FIG. 24 is a diagram illustrating a second example of the protection mechanism of the sensor.

FIG. 25 is a diagram illustrating a modification of the protection mechanism of the sensor.

FIG. 26 is a block diagram showing a configuration example of a computer.

### MODE FOR CARRYING OUT THE INVENTION

Hereinafter, a mode for carrying out the present technology will be described. The description is given in the following order.
1. Background of present technology
2. Embodiment
3. Modification
4. Others

### 1. Background of Present Technology

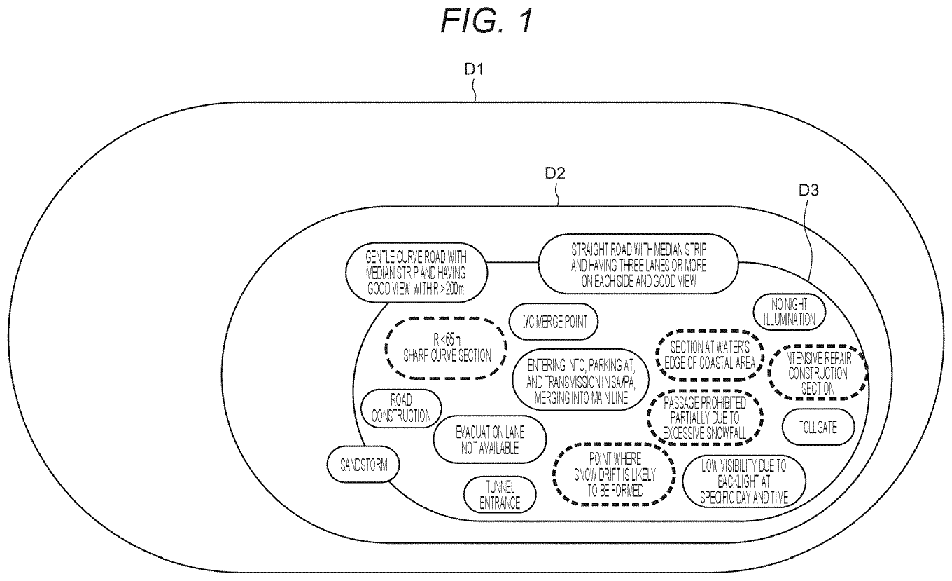

First, the background of the present technology will be described with reference to FIG. 1.

As a method of setting a range of using the automated driving, for example, there are two types of methods, a top-down approach and a bottom-up approach. In the top-down approach, an ODD which is a range to which the automated driving is applied is determined in advance, design and development of a vehicle are performed so that safety of the automated driving can be guaranteed within the range of the ODD, and the use of the automated driving is permitted. On the other hand, in the bottom-up approach, an ODD applicable by a vehicle is set on the basis of the performance of the designed and developed vehicle, and the use of the automated driving is permitted within a range of the set ODD.

Here, the ODD is a travel environment condition which is a premise that an automated driving system operates normally. The following are examples of the travel environment conditions used for the ODD.
Road condition (expressway, general road, number of lanes, presence or absence of lanes, etc.)
Geographic condition (urban area, mountain area, etc.)
Environmental conditions (weather, night-time restrictions, etc.)
Vehicle condition (performance, function, characteristic, equipment, maintenance status, degradation over time, presence or absence of failure, amount of load, etc.) and driver condition (health state, wakefulness level, possibility of returning to driving, etc.)
Other conditions (speed limit, restriction to specified path only, etc.)

Then, at the vehicle design and development stage, a verification test is performed under conditions defined by the ODD. That is, a verification test is performed as to whether or not the automated driving at level 3 and level 4 can actually be safely performed under the travel environment conditions including vehicle equipment and the like defined by the ODD. The verification test is performed, for example, for each scenario for which safety is guaranteed by the ODD. The scenario is a scene in which a vehicle is assumed to travel, and is defined by a combination of the travel environment conditions described above. Furthermore, in the verification test, not only a field test actually using a vehicle but also a simulation test using a computer or the like is performed.

FIG. 1 illustrates an example of ranges of the travel environment conditions.

The range D1 indicates a range including the travel environment conditions under which a vehicle 1 possibly travel in the actual case.

The range D2 indicates a global ODD range in which special travel environment conditions are not considered. For example, a well-managed expressway or the like corresponds to the range D2.

Here, the global ODD is, for example, a specific designated expressway in which a plurality of lanes on one side and evacuation lanes are always installed on a route, a closed road environment space in which an environment that a concerned vehicle can travel in an automated manner is prepared, or the like. That is, the global ODD is, for example, an operation design area that satisfies a wide range and comprehensive specified condition possibly including local unique conditions that can be variously defined and operated according to the design concept of the vehicle.

Therefore, the global ODD includes a straight road, a sharp curve road with a small curvature, an entrance and an exit of a tunnel, and the like, and for example, even at the same time, whether or not the vehicle can pass each section by automated driving changes depending on conditions such as whether or not the road surface is frozen and how sunlight shines. That is, the travel environment condition of each section of the global ODD does not always satisfy the condition in which the safety is confirmed by the verification test in advance of the automated driving system included in the vehicle. Therefore, even in a specific expressway that is expected to pass all sections by the automated driving at level 4 in a broad sense, there is a possibility that a section that does not correspond to the ODD at level 4 and cannot pass by the automated driving at level 4 in individual small sections occurs.

It is necessary to distinguish a local ODD for a small stripped section determined by such an individual condition from the global ODD. Furthermore, in order to allow traveling by the automated driving in all sections of the global ODD, it is assumed that confirmation has been made by the verification test that the automated driving is possible in a use case in a scenario corresponding to each section to be described in detail below.

The range D3 includes special travel environment conditions, and indicates a range of travel environment conditions included in a use case to be evaluated in the verification test. Each oval frame in the range D3 indicates an example of the special travel environment condition.

Among the oval frames, the travel environment conditions shown in the dotted oval frame indicate examples of travel environment conditions that are not applicable to the automated driving at level 4 because safety cannot be guaranteed. This corresponds to sections in which, for example, even if the prior information acquired at the stage of setting a travel plan is not recognized as the constraint condition and the condition is set to the section (global ODD) in which the automated driving at level 4 is possible, after the travel is actually started, it is found that the condition is out of range of allowing the automated driving at level 4, and the condition is excluded from the ODD of the automated driving at level 4. Examples of the sections that are excluded from the ODD of the automated driving at level 4 for the concerned vehicle include, for example, a section with a sharp curve with a radius of less than 65 m, a section at the water's edge of a coastal area, a road section under intensive repair work, a point where a snow drift is likely to be formed, a section where traveling is partially prohibited due to excessive snowfall, and the like.

Then, the safety of the automated driving is confirmed by the verification test on the basis of various possible scenario collections, a combination of conditions and states under which each final automated driving level can be used is determined on the basis of various possible travel environment conditions, and the range of the ODD of each automated driving level is determined. For example, a set of sections is determined to be in the range of the ODD, the set of sections being finally set by excluding the sections that the automated driving is not applicable due to individual special conditions within the range D3, and the safety of automated driving of the vehicle is guaranteed.

Note that it is not possible to perform the verification test on all combinations of travel environment conditions included in the ODD. Therefore, the verification test is performed by extracting some control points that determine a boundary of each scenario condition. The control point is, for example, a parameter indicating a specific content, a value, or the like of each travel environment condition.

In the actual travel planning and operation, the automated driving system refers to, for example, collected information such as vehicle information, driver information, map information along a travel plan route and individual unique conditions, weather information, traveling time zone, and season information, and determines whether or not the vehicle can actually travel at a preset automated driving level for each section. Then, on the basis of the information acquired during traveling, the automated driving system dynamically performs ODD exclusion processing, a notification of a change in the automated driving level to the driver, a change in the automated driving control, and the like in accordance with a change in the travel environment condition.

Furthermore, another important factor is that, because the boundary of the ODD indicating the availability of each automated driving level is affected by a combination of various conditions, the determination of the boundary becomes ambiguous from the viewpoint of the driver. Therefore, there is no explicit index indicating what kind of environment or condition changes the applicable automated driving level on the basis of when the vehicle is actually used, and there is a risk that the action required by the driver cannot be uniquely determined.

One of the easy-to-understand cases is a case where the applicable automated driving level changes due to a combination of a degree of dirt of a window seal in front of a camera used for front recognition and a condition of direct sunlight. For example, when direct sunlight enters in a case where the windshield is dirty, flare occurs in the camera used for front recognition, and there is a case where recognition of a tunnel in front, a lane line of a road in a shaded range, a vehicle, or the like fails, and the condition is deviated from the ODD in which the automated driving is possible.

Incidentally, in a case where a person drives a vehicle, even if some trouble occurs, the person takes a temporal measure to continue driving as much as possible and head to the destination without immediately stopping driving.

For example, the driver appropriately takes various measures to reduce the risk and ensure safety for various situations that the driver feels as a risk at times, such as eye fatigue, reduction in visibility due to rain, fog, or the like, dirt on the windshield, reduction in effectiveness of a wiper, slippage of the road surface, presence or absence and a vehicle type of a following vehicle, and the like, particularly before continuation of traveling becomes difficult. Specifically, for example, the driver takes measures such as slowing down the vehicle, increasing an inter-vehicle distance from a vehicle ahead, taking a break at a service area, stopping at the service area and wiping the windshield to improve visibility.

For example, even if a local defect such as a decrease in tire air pressure, an engine malfunction, a decrease in the degree of effect of a brake, an abnormal noise, running out of lamp, or a crack of the windshield caused by a flying stone, in a case where the vehicle can travel safely by being carefully driven at low speed, there are cases where the driver only takes a temporal measure and drives to a maintenance factory or the like.

Meanwhile, also for the automated vehicle, it is also desired that, similarly to the case where a person drives the vehicle, even if some trouble occurs, the automated driving function is not completely stopped immediately and the driver is not requested to perform the manual driving, but the automated driving is flexibly performed and is continued as long as possible within a range in which the vehicle can travel without any problem in safety. However, in order to increase the flexibility of operation of the automated driving and widen a degree of freedom, the operation desirably includes an appropriate intervention in travel control by the driver.

Meanwhile, in order to improve the flexibility of the automated driving, the automated driving system needs to correspond to more patterns of travel environment conditions including time degradation of the vehicle equipment. However, it is not practically possible to perform the verification test of validity of safety for all patterns of assumed travel environment conditions, in consideration of necessary cost, time, and the like.

For example, recognition capability of the situation around the vehicle changes due to various factors such as time degradation of and dirt on the equipment mounted on the vehicle, and environment conditions including weather conditions. For example, the acceleration and deceleration performance of the vehicle, the safe traveling speed on a slope, a curve, or the like changes depending on factors such as the amount of load and the loading method. For example, it is not realistic to perform the verification test on all these patterns of travel environment conditions.

On the other hand, if the pattern of the travel environment condition for which the verification test has not been performed is excluded from the application of the automated driving, the flexibility of the automated driving decreases. For example, when the travel environment condition changes due to a trouble or the like, the automated driving is immediately stopped, and if the driver cannot respond to the manual driving, the vehicle undergoes an emergency stop by a Minimal Risk Maneuver (MRM) or the like. Then, there is a risk that excessive performing of the emergency stop causes, for example, rear-end collision by the following vehicle, traffic congestion, or the like.

With regard to this, the present technology improves the flexibility of the operation of the automated driving with respect to the change in the travel environment condition due to various situations that actually occur.

Furthermore, in order to improve the flexibility of the automated driving, it is necessary for the automated driving system and the driver to cooperate with each other while the driver takes appropriate measures as necessary. For example, there are cases where the driver is required to immediately return to the manual driving, to temporarily return to the manual driving, or to remove or reduce a trouble such as an abnormality of the vehicle.

With regard to this, the present technology enables the user to appropriately take necessary measures for a vehicle that performs automated driving.

Then, by improving the flexibility of the operation of the automated driving, the vehicle can appropriately respond to various travel environment conditions, and as a result, the safety of the automated driving is improved. Furthermore, the convenience of the user of the vehicle including the driver is improved. What is particularly important is a social aspect in which the case of the automated driving system malfunctioning during traveling to cause the emergency stop or inadvertent deceleration due to execution of an excessive MRM is suppressed, and as a result, an occurrence of the rear-end accident or the traffic congestion is prevented.

### 2. Embodiment

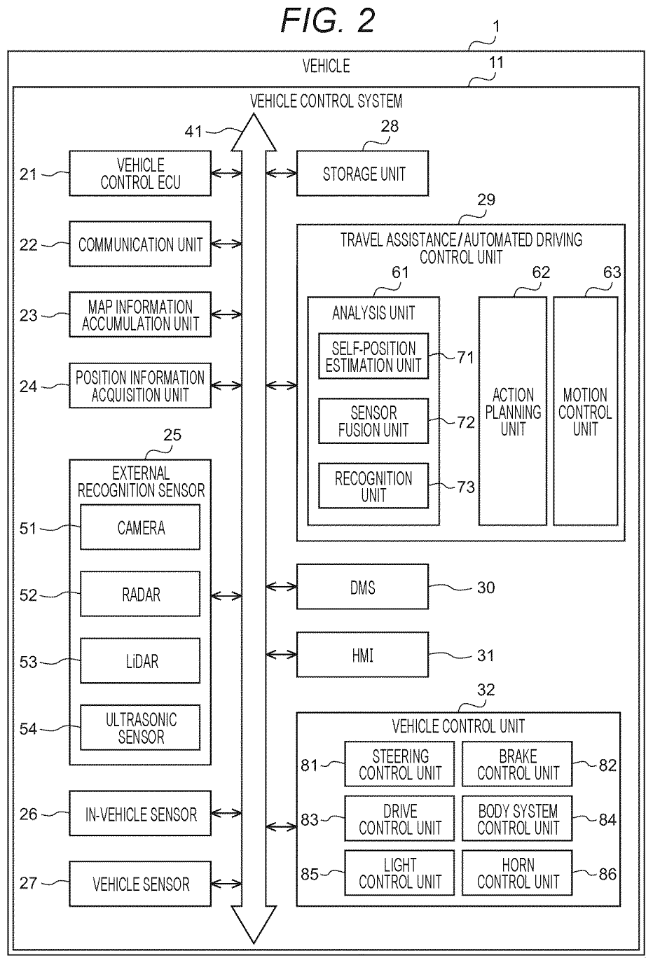

Next, an embodiment of the present technology is described with reference to FIGS. 2 to 21.

### <Configuration Example of Vehicle Control System>

FIG. 2 is a block diagram illustrating an example configuration of a vehicle control system 11 that is an example of a moving apparatus control system to which the present technology is applied.

The vehicle control system 11 is provided in a vehicle 1, and performs processing relating to travel assistance and automated driving of the vehicle 1.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a travel assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance/automated driving control unit 29, the driver monitoring system (DMS) 30, the human machine interface (HMI) 31, and the vehicle control unit 32 are communicably connected to each other via a communication network 41. The communication network 41 includes, for example, an in-vehicle communication network, a bus, or the like that conforms to a digital bidirectional communication standard such as a controller area network (CAN), a local interconnect network (LIN), a local area network (LAN), FlexRay (registered trademark), or Ethernet (registered trademark). The communication network 41 may be selectively used depending on the type of data to be transmitted. For example, the CAN may be applied to data regarding vehicle control, and the Ethernet may be applied to large-volume data. Note that, in some cases, each unit of the vehicle control system 11 is directly connected not via the communication network 41 but by, for example, wireless communication that assumes communication at a relatively short distance, such as near field communication (NFC) or Bluetooth (registered trademark).

Note that, hereinafter, in a case where each unit of the vehicle control system 11 performs communication via the communication network 41, description of the communication network 41 will be omitted. For example, in a case where the vehicle control ECU 21 and the communication unit 22 perform communication via the communication network 41, it will be simply described as the vehicle control ECU 21 and the communication unit 22 performing communication.

For example, the vehicle control ECU 21 includes various processors such as a central processing unit (CPU) and a micro processing unit (MPU). The vehicle control ECU 21 controls all or some of the functions of the vehicle control system 11.

The communication unit 22 communicates with various devices inside and outside the vehicle, other vehicles, servers, base stations, and the like, and transmits and receives various types of data. At this time, the communication unit 22 can perform communication by using a plurality of communication systems.

Communication with the outside of the vehicle executable by the communication unit 22 will be schematically described. The communication unit 22 communicates with a server (hereinafter referred to as an external server) or the like present on an external network via a base station or an access point by, for example, a wireless communication system such as fifth generation mobile communication system (5G), long term evolution (LTE), dedicated short range communications (DSRC), or the like. The external network with which the communication unit 22 performs communication is, for example, the Internet, a cloud network, a company-specific network, or the like. A communication system by which the communication unit 22 communicates with the external network is not particularly limited as long as the system is a wireless communication system that can perform digital bidirectional communication at a predetermined communication speed or higher and at a predetermined distance or longer.

Furthermore, the communication unit 22 can communicate with a terminal present in the vicinity of a host vehicle, by using, for example, a peer to peer (P2P) technology. The terminal present in the vicinity of the host vehicle is, for example, a terminal attached to a mobile object moving at a relatively low speed such as a pedestrian or a bicycle, a terminal installed in a store or the like with a position fixed, or a machine type communication (MTC) terminal. Moreover, the communication unit 22 can also perform V2X communication. The V2X communication refers to, for example, communication between an own vehicle and another object, such as communication between an own vehicle and another vehicle (vehicle-to-vehicle), communication between an own vehicle and a roadside machine (vehicle-to-infrastructure), communication between an own vehicle and the home (vehicle-to-home), or communication between an own vehicle and a terminal carried by a pedestrian (vehicle-to-pedestrian).

For example, the communication unit 22 can receive a program for updating software for controlling a motion of the vehicle control system 11 from the outside (Over The Air (OTA)). The communication unit 22 can further receive map information, traffic information, information regarding the surroundings of the vehicle 1, and the like from the outside. Furthermore, for example, the communication unit 22 can transmit information regarding the vehicle 1, information regarding the surroundings of the vehicle 1, and the like to the outside. The information regarding the vehicle 1 to be transmitted to the outside by the communication unit 22 includes, for example, data indicating a state of the vehicle 1, a recognition result from a recognition unit 73, or the like. Moreover, for example, the communication unit 22 performs communication corresponding to a vehicle emergency call system such as eCall.

For example, the communication unit 22 receives an electromagnetic wave transmitted by Vehicle Information and Communication System (VICS) (registered trademark), such as a radio wave beacon, an optical beacon, or FM multiplex broadcasting.

Communication that can be performed between the communication unit 22 and the inside of a vehicle will be schematically described. The communication unit 22 can communicate with each device in the vehicle by using, for example, wireless communication. The communication unit 22 can perform, for example, wireless communication with an in-vehicle device by a communication system allowing digital bidirectional communication at a predetermined communication speed or higher by wireless communication, such as wireless LAN, Bluetooth, NFC, or wireless universal serial bus (WUSB). Besides this, the communication unit 22 can also communicate with each device in the vehicle by using wired communication. For example, the communication unit 22 can communicate with each device in the vehicle by wired communication via a cable connected to a connection terminal not illustrated. The communication unit 22 can communicate with each device in the vehicle by, for example, a communication system allowing digital bidirectional communication at a predetermined communication speed or higher by wired communication, such as universal serial bus (USB), high-definition multimedia interface (HDMI) (registered trademark), or mobile high-definition link (MHL).

Here, the in-vehicle device refers to, for example, a device that is not connected to the communication network 41 in the vehicle. As the in-vehicle device, for example, a mobile device or a wearable device carried by an occupant such as a driver, an information device brought into the vehicle and temporarily installed, or the like is assumed.

The map information accumulation unit 23 accumulates either or both of a map acquired from the outside and a map created by the vehicle 1. For example, the map information accumulation unit 23 accumulates a three-dimensional high-precision map, a global map having a lower precision than the precision of the high-precision map but covering a wider area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from the external server or the like. The point cloud map is a map including point clouds (point cloud data). The vector map is, for example, a map in which traffic information such as a lane and a position of a traffic light is associated with a point cloud map and adapted to an advanced driver assistance system (ADAS) or autonomous driving (AD).

The point cloud map and the vector map may be provided from, for example, the external server or the like, or may be created in the vehicle 1 as a map for performing matching with a local map to be described later on the basis of a result of sensing by a camera 51, a radar 52, a LiDAR 53, or the like, and may be accumulated in the map information accumulation unit 23. Furthermore, in a case where a high-precision map is provided from an external server or the like, for example, map data of several hundred meters square regarding a planned path on which the vehicle 1 is about to travel is acquired from the external server or the like in order to reduce the communication capacity.

The position information acquisition unit 24 receives a global navigation satellite system (GNSS) signal from a GNSS satellite, and acquires position information of the vehicle 1. The acquired position information is supplied to the travel assistance/automated driving control unit 29. Note that the position information acquisition unit 24 may acquire the position information by using not only a system using the GNSS signal, but also, for example, a beacon.

The external recognition sensor 25 includes various sensors that are used to recognize the situation outside the vehicle 1, and supplies sensor data from each sensor to each unit of the vehicle control system 11. The type and the number of the sensors included in the external recognition sensor 25 are optionally selected.

For example, the external recognition sensor 25 includes the camera 51, the radar 52, the light detection and ranging or laser imaging detection and ranging (LiDAR) 53, and an ultrasonic sensor 54. Besides this, the external recognition sensor 25 may have a configuration including one or more types of sensors among the camera 51, the radar 52, the LiDAR 53, and the ultrasonic sensor 54. The numbers of the cameras 51, the radars 52, the LiDARs 53, and the ultrasonic sensors 54 are not limited as long as the number thereof can be practically installed in the vehicle 1. Furthermore, the types of sensors included in the external recognition sensor 25 are not limited to this example, and the external recognition sensor 25 may include a sensor of other types. An example of the sensing area of each sensor included in the external recognition sensor 25 will be described later.

Note that an imaging method of the camera 51 is not particularly limited. For example, cameras of various imaging methods such as a time of flight (ToF) camera, a stereo camera, a monocular camera, and an infrared camera, the imaging methods being able to perform distance measurement, can be applied to the camera 51, as necessary. Besides this, the camera 51 may simply acquire a captured image regardless of distance measurement.

Furthermore, for example, the external recognition sensor 25 can include an environment sensor for detecting the environment around the vehicle 1. The environmental sensor is a sensor for detecting an environment such as weather, climate, and brightness, and can include, for example, various sensors such as a raindrop sensor, a fog sensor, a sunshine sensor, a snow sensor, and an illuminance sensor.

Moreover, for example, the external recognition sensor 25 includes a microphone used for detecting sound around the vehicle 1, a position of a sound source, and the like.

The in-vehicle sensor 26 includes various sensors for detecting information inside the vehicle, and supplies sensor data from each sensor to each unit of the vehicle control system 11. The type and the number of various sensors included in the in-vehicle sensor 26 are not particularly limited as long as the type and the number of the sensors can be practically installed in the vehicle 1.

For example, the in-vehicle sensor 26 can include one or more types of sensors among a camera, a radar, a seating sensor, a steering wheel sensor, a microphone, and a biometric sensor. As the camera included in the in-vehicle sensor 26, for example, cameras of various imaging methods by which a distance can be measured, such as a ToF camera, a stereo camera, a monocular camera, and an infrared camera, can be used. Besides this, the camera included in the in-vehicle sensor 26 may be a camera that simply acquire a captured image regardless of distance measurement. The biometric sensor included in the in-vehicle sensor 26 is provided, for example, on a seat, a steering wheel, or the like and detects various types of biometric information of an occupant such as a driver.

The vehicle sensor 27 includes various sensors for detecting the state of the vehicle 1, and supplies sensor data from each sensor to each unit of the vehicle control system 11. The type and the number of various sensors included in the vehicle sensor 27 are not particularly limited as long as the type and the number of the sensors can be practically installed in the vehicle 1.

For example, the vehicle sensor 27 includes a speed sensor, an acceleration sensor, an angular velocity sensor (gyro sensor), and an inertial measurement unit (IMU) obtained by integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of rotations of an engine or a motor, an air pressure sensor that detects air pressure of a tire, a slip rate sensor that detects a slip rate of the tire, and a wheel speed sensor that detects the rotation speed of a wheel. For example, the vehicle sensor 27 includes a battery sensor that detects remaining battery power and a temperature of a battery, and an impact sensor that detects external impact.

The storage unit 28 includes at least one of a nonvolatile storage medium or a volatile storage medium, and stores data and a program. The storage unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be used as a storage medium. The storage unit 28 stores various types of programs and data used by each unit of the vehicle control system 11. For example, the storage unit 28 includes an event data recorder (EDR) and a data storage system for automated driving (DSSAD), and stores information on the vehicle 1 before and after an event such as an accident, and information acquired by the in-vehicle sensor 26.

For example, the storage unit 28 stores information indicating how the travel assistance/automated driving control unit 29 has made the ODD application determination and has transmitted the application condition to the driver via the HMI 31. Furthermore, the storage unit 28 stores, for example, information indicating how each piece of notification information has affected the state of the driver, an action taken by the driver as a measure, and the like on the basis of a result of detection and evaluation of whether each piece of notification information has been normally transmitted to the driver by the DMS 30.

For example, the storage unit 28 stores a vehicle characteristics dictionary indicating various characteristics of the vehicle 1.

For example, the storage unit 28 stores a driver return characteristics dictionary. For example, the driver return characteristics dictionary includes information regarding a return time and the like until the driver returns from a secondary task other than the manual driving to the manual driving. For example, the driver return characteristics dictionary includes information specific to the driver regarding a relative relationship between the type of the secondary task and the return time, a relative relationship between an index of the observable biometric information of the driver and the return time, and the like. For example, the driver return characteristics dictionary is generated on the basis of a result and the like of recognition processing of the state of the driver by the DMS 30. Furthermore, because the distribution characteristics of the time required from the return request to the return of the driver has a constant distribution under the influence of multiple factors such as fatigue and lack of sleep, information specific to the driver can be obtained by further calculating advance notification of the return request, return notification, estimation of return transition, delay with respect to the estimation, and the like.

For example, the storage unit 28 stores a measure-taking history dictionary. The measure-taking history dictionary has recorded therein, for example, a history of whether or not a measure-taking method selected by the driver is followed in a case where the vehicle control system 11 proposes the measure-taking method for a section (hereinafter, referred to as an automated driving restricted section) in which the automated driving is restricted as described later.

Note that the automated driving restricted section is, for example, a section in which the automated driving cannot be executed and a section in which the automated driving can be executed under constraint conditions such as speed restriction and restriction of an inter-vehicle distance. For example, the section in which the automated driving at level 4 can be executed without the constraint condition is outside the range of the automated driving restricted section. Meanwhile, the section where the automated driving at level 3 is executable is within the range of the automated driving restricted section because the constraint condition is that the driver is to prepare to be able to return to the manual driving.

For example, the storage unit 28 stores a driver lifestyle log. The driver lifestyle log has recorded therein, for example, histories of various actions of the driver. The driver lifestyle log is acquired from, for example, a portable information terminal such as a smartphone carried by the driver, a wearable device worn by the driver, or the like. What is particularly important in vehicle control is factors such as fatigue, lack of sleep, circadian rhythm, and a sleep cycle, the factors affecting the characteristics of the driver returning to driving and the awakening state at the time of the automated driving at level 4 or lower being mixed.

For example, the storage unit 28 stores a look up table (LUT). Although details will be described later, the LUT is, for example, a table obtained by converting the ODD of the vehicle 1 into data.

For example, the storage unit 28 stores a control matrix. Although details will be described later, for example, the control matrix is software including a function of deriving the automated driving level and the constraint condition that can be handled by the vehicle 1, on the basis of the travel environment condition. The constraint condition is, for example, a condition serving as a constraint for the vehicle 1 to execute automated driving at a certain automated driving level, and is, for example, a condition regarding a speed, an inter-vehicle distance, and the like of the vehicle 1.

The travel assistance/automated driving control unit 29 controls travel assistance and automated driving of the vehicle 1. For example, the travel assistance/automated driving control unit 29 includes an analysis unit 61, an action planning unit 62, and a motion control unit 63.

Normally, automated driving control is classified into three elements (three stages): perception/cognition, determination, and operation/action. The classification of these three elements is, for example, processing in which the vehicle control system 11 independently performs the automated driving control, and is different from the main problem of the present technology, and thus, detailed description thereof is omitted.

In the present technology, among the processing of the travel assistance/automated driving control unit 29, the processing mainly responsible for the planning stage of the control will be described in detail. For example, elements of making the travel plan are generally classified by groups of a navigation system. On the other hand, in the present technology, as an aspect not included in the conventional navigation system, use of the automated driving function according to not only the road environment but also the self-diagnosis state, the driver state, and the like of the vehicle control system 11 will be described in detail. Furthermore, in the present technology, while it is necessary for the driver to actively participate in driving complementarily due to various situation changes on a route where the automated driving function cannot be used, motion control regarding analysis of each section, an action plan at the automated driving level, a measure-taking policy, and the like will be described in detail.

The analysis unit 61 performs analysis processing on the vehicle 1 and a situation around the vehicle 1. The analysis unit 61 includes a self-position estimation unit 71, a sensor fusion unit 72, and the recognition unit 73.

The self-position estimation unit 71 estimates the self-position of the vehicle 1, on the basis of sensor data from the external recognition sensor 25 and the high-precision map accumulated in the map information accumulation unit 23. For example, the self-position estimation unit 71 generates a local map on the basis of the sensor data from the external recognition sensor 25, and performs matching between the local map and the high-precision map to estimate the self-position of the vehicle 1. The position of the vehicle 1 is based on, for example, the center of a rear wheel pair axle.

The local map is, for example, a three-dimensional high-precision map created by using a technology such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 1 is divided into grids (lattices) of a predetermined size, and an occupancy state of an object is indicated in units of grids. The occupancy state of the object is represented by, for example, presence or absence or an existence probability of the object. The local map is also used for, for example, detection processing and recognition processing of the situation outside the vehicle 1 by the recognition unit 73.

Note that the self-position estimation unit 71 may estimate the self-position of the vehicle 1 on the basis of position information acquired by the position information acquisition unit 24 and sensor data from the vehicle sensor 27.

The sensor fusion unit 72 performs sensor fusion processing of combining a plurality of different types of sensor data (for example, image data supplied from the camera 51 and sensor data supplied from the radar 52), to acquire new information. Methods for combining different types of sensor data include integration, fusion, association, and the like.

The recognition unit 73 executes detection processing of detecting the situation outside the vehicle 1 and recognition processing of recognizing the situation outside the vehicle 1.

For example, the recognition unit 73 performs the detection processing and the recognition processing of the situation outside the vehicle 1 on the basis of information from the external recognition sensor 25, information from the self-position estimation unit 71, information from the sensor fusion unit 72, and the like.

Specifically, for example, the recognition unit 73 performs the detection processing, the recognition processing, and the like of an object around the vehicle 1. The detection processing of the object is, for example, processing of detecting presence or absence, a size, a shape, a position, a motion, and the like of the object. The recognition processing of the object is, for example, processing of recognizing an attribute such as a type of the object or identifying a specific object. However, the detection processing and the recognition processing are not always clearly distinguished from each other and overlap each other in some cases.

For example, the recognition unit 73 detects an object around the vehicle 1 by performing clustering in which point clouds based on sensor data from the radar 52, the LiDAR 53, or the like, are classified into clusters of point clouds. With this arrangement, the presence and absence, the size, the shape, and the position of the object around the vehicle 1 are detected.

For example, the recognition unit 73 performs tracking to follow a motion of the cluster of point clouds classified by clustering, to detect a motion of the object around the vehicle 1. With this arrangement, the speed and the advancing direction (movement vector) of the object present around the vehicle 1 are detected.

For example, the recognition unit 73 detects or recognizes a vehicle, a person, a bicycle, an obstacle, a structure, a road, a traffic light, a traffic sign, a road sign, and the like, on the basis of image data supplied from the camera 51. Furthermore, the recognition unit 73 may recognize the type of the object around the vehicle 1 by performing recognition processing such as semantic segmentation.

For example, the recognition unit 73 can perform recognition processing for traffic rules around the vehicle 1 on the basis of a map accumulated in the map information accumulation unit 23, a result of estimation of the self-position by the self-position estimation unit 71, and a result of recognition of the object around the vehicle 1 by the recognition unit 73. Through this processing, the recognition unit 73 can recognize a position and a state of the traffic light, the content of a traffic sign and a road sign, the content of traffic regulations, a travelable lane, and the like.

For example, the recognition unit 73 can perform recognition processing for a surrounding environment of the vehicle 1. As the surrounding environment to be recognized by the recognition unit 73, weather, air temperature, humidity, brightness, road surface conditions, and the like are assumed.

The action planning unit 62 creates an action plan for the vehicle 1. For example, the action planning unit 62 creates the action plan by performing processing of path planning and path following.

Note that the path planning (global path planning) is processing of planning a rough path from a start to a goal. This path planning also includes processing called a trajectory plan in which trajectory generation (local path planning) is performed, the local path planning enabling safe and smooth advancing in the vicinity of the vehicle 1 in consideration of the motion characteristics of the vehicle 1 in the planned path.

For example, the action planning unit 62 creates and changes the travel plan from the start to the goal by executing the path planning on the basis of the travel environment condition, a control matrix stored in the storage unit 28, and the like. The travel plan includes, for example, a path (hereinafter, referred to as a planned path) from the start to the goal, an automated driving level to be applied in each section on the planned path, and a constraint condition which is a condition that becomes constraint for executing the automated driving of the applied automated driving level.

For example, the action planning unit 62 creates a measure-taking method for the automated driving restricted section to be proposed to the driver, on the basis of the travel environment condition, the control matrix stored in the storage unit 28, and the like.

The path following is processing of planning a motion for safe and accurate travel along a path planned by the path planning within a planned time. For example, the action planning unit 62 can calculate a target speed and a target angular velocity of the vehicle 1, on the basis of a result of the path following processing.

The motion control unit 63 controls the motion of the vehicle 1 to achieve the action plan created by the action planning unit 62.

For example, the motion control unit 63 controls a steering control unit 81, a brake control unit 82, and a drive control unit 83 included in the vehicle control unit 32 described later, and performs acceleration and deceleration control and direction control so that the vehicle 1 advances the path calculated by the trajectory planning. For example, the motion control unit 63 performs coordinated control for the purpose of achieving the ADAS functions such as collision avoidance or impact mitigation, following traveling, vehicle-speed maintaining traveling, warning of collision of the own vehicle, warning of lane departure of the own vehicle, and the like. For example, the motion control unit 63 performs coordinated control for the purpose of automated driving or the like in which a vehicle autonomously travels without depending on the operation by the driver.

As described above, the automated driving control is executed by being classified into three elements of perception/cognition, determination, and operation/action.

Alternatively, in a macroscopic view of the entire travel plan, a function of capturing various influences in a longer-term view, planning and recognizing the organic intervention of the driver with respect to the travel environment condition dynamically changing in the middle of the travel plan, performing agreement and selection of a measure-taking method, and performing plan change and the measure-taking method according to the preference of the driver will be described below. Furthermore, a function regarding the HMI that promotes appropriate and timely involvement of the driver will be described below.

Conceptually, in a case where a person makes a driving plan and moves for a long distance, the person does not perceive/cognize the event in front of the person and makes steering determination only for the latest action, but performs operation control including action determination based on information acquired in advance as knowledge although the person cannot directly see the future. In the present technology, for example, the operation control therefor is supported. In order for the driver to make a correct determination, information converted into certain interpretable information directly linked to the action determination needs to be presented to the driver. Such a role is required by the HMI 31. Details will be described below.

The DMS 30 performs authentication processing on the driver, recognition processing on a state of the driver, and the like, on the basis of sensor data from the in-vehicle sensor 26, data input to the HMI 31 described later, the driver lifestyle log stored in the storage unit 28, and the like. As the state of the driver to be recognized, for example, a physical condition, a wakefulness level, a concentration level, a fatigue level, a line-of-sight direction, a drunkenness level, a driving operation, a posture, and the like are assumed.

Furthermore, for example, in a case where the driver selects the measure-taking method proposed by the action planning unit 62 for the automated driving restricted section, the DMS 30 monitors whether or not the driver has followed the selected measure-taking method. For example, the DMS 30 records information indicating a monitoring result as to whether or not the driver has followed the selected measure-taking method, in the measure-taking history dictionary stored in the storage unit 28.

Note that the DMS 30 may perform authentication processing on an occupant other than the driver, and recognition processing to recognize the state of the occupant. Furthermore, for example, the DMS 30 may perform recognition processing on the condition inside the vehicle on the basis of sensor data from the in-vehicle sensor 26. As the condition inside the vehicle to be recognized, for example, a temperature, a humidity, brightness, odor, or the like are assumed.

Note that, when the full automated driving at level 4 is realized in the future, it is assumed that a case occurs in which a plurality of driver candidates move during traveling and change the driving control. Therefore, it is useful to associate the authentication processing of a plurality of persons with the authentication record, or associate the mutual notification between the driver and the system for each takeover event from the automated driving to the manual driving with the notification cognitive information for recording and saving, in order to clarify the driving responsibility and prevent incomplete notification transmission.

The HMI 31 receives inputs of various types of data, instructions, and the like, and presents various types of data to the driver and the like.

The input of data through the HMI 31 will be schematically described. The HMI 31 includes an input device for a person to input data. The HMI 31 generates an input signal on the basis of data, an instruction, or the like that has been input through the input device, and supplies the input signal to each unit of the vehicle control system 11. The HMI 31 includes, for example, an operator such as a touch panel, a button, a switch, and a lever as the input device. Besides this, the HMI 31 may further include an input device that can have information input by a method such as voice and gesture other than manual operation. Moreover, the HMI 31 may use, as an input device, for example, a remote control device using infrared rays or radio waves, or an external connection device such as a mobile device or a wearable device compatible with operations of the vehicle control system 11.

Presentation of data by the HMI 31 will be schematically described. The HMI 31 generates visual information, auditory information, and tactile information for the occupant or the outside of the vehicle. Furthermore, the HMI 31 performs output control to control outputting, output contents, the output timing, the output method, and the like of each piece of the generated information. The HMI 31 generates and outputs, as the visual information, information indicated by, for example, images or light such as an operation screen, a display of the state of the vehicle 1, a warning display, and a monitor image indicating a situation around the vehicle 1. Furthermore, the HMI 31 generates and outputs, as the auditory information, information indicated by, for example, sounds such as voice guidance, a warning sound, and a warning message, for example. Moreover, the HMI 31 generates and outputs, as the tactile information, information given to the tactile sense of the occupant by, for example, force, vibration, motion, or the like. Moreover, the HMI 31 may also use an olfactory sense (scent, malodor) or the like in order to cause awareness of abnormality in the vehicle 1, a call attention, and a relaxation effect.

Note that, in particular, in a use mode of the automated driving at level 4 or higher in which the user can move the seating position, it is also assumed a case where the user leaves the seat and moves to the cargo bed or the like. Therefore, by performing wireless transmission to a wearable device of such as a wristwatch type or a ring type, a nomadic device, or the like, the extended function of the HMI 31 may be made available in these devices.

As an output device through which the HMI 31 outputs the visual information, for example, a display device that presents the visual information by displaying an image by itself or a projector device that presents the visual information by projecting an image can be applied. Note that the display device may be, for example, a device that displays the visual information in the field of view of the occupant, such as a head-up display (HUD), a transmissive display, a wearable device having an augmented reality (AR) function, or a direct retinal projection device as well as a display device having a normal display. Furthermore, in the HMI 31, a display device included in a navigation device, an instrument panel, a camera monitoring system (CMS), an electronic mirror, A-pillar and window frame, a lamp disposed in a steering wheel or the like, or the like provided in the vehicle 1 can also be used as the output device that outputs the visual information.

As the output device through which the HMI 31 outputs the auditory information, for example, an audio speaker, headphones, or earphones can be used.

As the output device through which the HMI 31 outputs the tactile information, for example, a haptics element using a haptics technology can be used. The haptics element is disposed, for example, at a portion to be touched by the occupant of the vehicle 1, such as the steering wheel or the seat.

Note that, in the haptics technology, it is not always necessary to use a dedicated haptics element such as a vibration device, and for example, equipment provided in the vehicle 1 may be used. For example, acceleration/deceleration drive control, control of a seating control motor, actuator drive control of power steering, and the like may be used for the haptics technology. In particular, by performing impulse control at that time, a large tactile sensation can be given to the driver even if the influence on the travel control is actually slight. For example, by applying a large negative gravitational acceleration G in a short time for a moment, a high sensory cognitive effect can be given to the driver to the extent that the deceleration of the vehicle 1 does not affect the inter-vehicle distance with the following vehicle.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of the steering system of the vehicle 1. The steering system includes, for example, a steering mechanism including the steering wheel and the like, an electric power steering, and the like. The steering control unit 81 includes, for example, a steering ECU that controls the steering system, an actuator that drives the steering system, and the like. Note that the steering control unit 81 may further perform advancing direction control of the vehicle 1 through rotation control of four wheels.

The brake control unit 82 performs detection, control, and the like of a state of the brake system of the vehicle 1. The brake system includes, for example, a brake mechanism including a brake pedal and the like, an antilock brake system (ABS), a regenerative brake mechanism, and the like. The brake control unit 82 includes, for example, a brake ECU that controls the brake system, an actuator that drives the brake system, and the like.

The drive control unit 83 performs detection, control, and the like of a state of the drive system of the vehicle 1. The drive system includes, for example, an accelerator pedal, a driving force generation device for generating driving force such as an internal combustion engine or a driving motor, a driving force transmission mechanism for transmitting the driving force to wheels, and the like. The drive control unit 83 includes, for example, a drive ECU that controls the drive system, an actuator that drives the drive system, and the like.

The body system control unit 84 performs detection, control, and the like of a state of a body system of the vehicle 1. The body system includes, for example, a keyless entry system, a smart key system, a power window device, a power seat, an air conditioner, an airbag, a seat belt, a shift lever, and the like. The body system control unit 84 includes, for example, a body system ECU that controls the body system, an actuator that drives the body system, and the like.

The light control unit 85 performs detection, control, and the like of states of various lights of the vehicle 1. As the lights to be controlled, for example, a headlight, a side lamp, a back light, a fog light, a turn signal, a brake light, a driver assistance matrix projection, a bumper display, an automated driving status and intention display lamp, and the like are assumed. The light control unit 85 includes a light ECU that controls the lights, an actuator that drives the lights, and the like.

The horn control unit 86 performs detection, control, and the like of a state of the car horn of the vehicle 1. The horn control unit 86 includes, for example, a horn ECU that controls the car horn, an actuator that drives the car horn, and the like.

### <Configuration Example of Information Processing Unit 101>

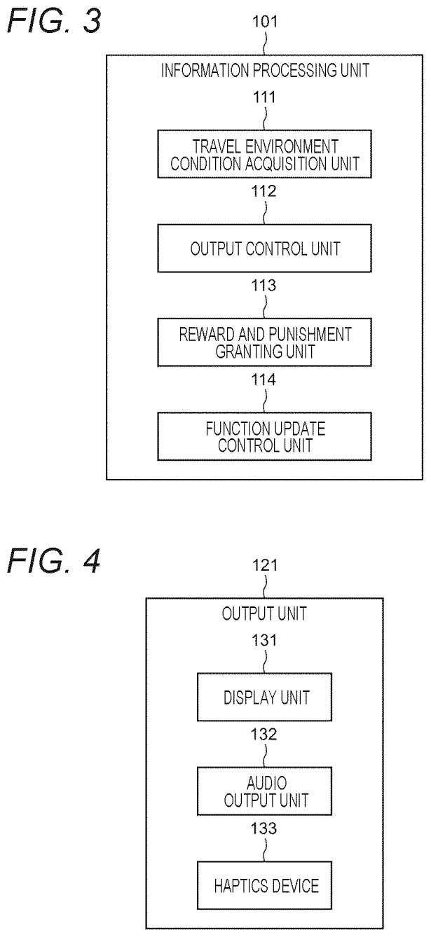

FIG. 3 illustrates a configuration example of an information processing unit 101 realized by the vehicle control ECU 21 and the like.

The information processing unit 101 includes a travel environment condition acquisition unit 111, an output control unit 112, a reward and punishment granting unit 113, and a function update control unit 114.

The travel environment condition acquisition unit 111 acquires information regarding various travel environment conditions necessary for the control of the automated driving such as the setting of the automated driving level of the vehicle 1. For example, the travel environment condition acquisition unit 111 communicates with various devices inside and outside the vehicle, other vehicles, servers, base stations, and the like via the communication unit 22, and acquires information regarding the travel environment condition around the planned path. For example, the travel environment condition acquisition unit 111 acquires information regarding the travel environment condition around the planned path on the basis of the map accumulated in the map information accumulation unit 23. For example, the travel environment condition acquisition unit 111 acquires a detection result or a recognition result of the situation outside the vehicle 1 from the recognition unit 73. For example, the travel environment condition acquisition unit 111 acquires the recognition result of the state of the occupant including the driver and the recognition result of the situation inside the vehicle from the DMS 30. For example, the travel environment condition acquisition unit 111 acquires a detection result of the state of each unit of the vehicle 1 from the vehicle control unit 32. For example, the travel environment condition acquisition unit 111 performs a motion diagnosis of each unit of the vehicle 1 or causes each unit of the vehicle 1 to perform the motion diagnosis and acquires the result.

The output control unit 112 controls output of the visual information, the auditory information, and the tactile information by an output unit 121 in FIG. 4.

The reward and punishment granting unit 113 gives an incentive or penalty to the driver on the basis of the monitoring result of the driver by the DMS 30 or the like. Specifically, for example, the reward and punishment granting unit 113 gives the incentive or penalty to the driver on the basis of the monitoring result of whether or not the driver has followed the measure-taking method presented by the action planning unit 62 and selected by the driver.

For example, the incentive and the penalty are used as means for evaluating whether the driver has been able to quickly and appropriately adapt from the automated driving to the manual driving in response to a request from the vehicle control system 11, and causing the driver to take measures with the automated driving without omission. On the other hand, the driver does not drive for the purpose of obtaining the incentive or avoiding the penalty.

An object of the present function is to prevent the driver from being excessively dependent on the automated driving, and to reduce unnecessary deceleration and activation of an emergency MRM or the like having a significant adverse effect on the following vehicle. Therefore, the vehicle control system 11 gives an advance notification to the driver at the appropriate timing, and gives a return promotion alarm or the like in stages when a delay occurs in the notification and measure taking. Then, a penalty is given in a case where the driver does not appropriately and quickly return to driving, and an incentive is given in a case where the driver appropriately and quickly returns to driving.

Here, the incentive and the penalty are determined by information provided to the driver by the vehicle control system 11 and whether the driver has made a decision on the basis of the information, scheduled to take a measure, and appropriately taken the measure in a timely manner according to a change in the situation or the like. Meanwhile, information for determining the necessity of taking the measure needs to be appropriately provided by the vehicle control system 11.

With regard to this, an important factor for determining the necessity of taking the measure is the travel environment condition used for determining the ODD applied to each section. Then, as will be described later, as a criterion for determining the measure-taking action of the driver, the travel environment condition such as the ODD and the state of the vehicle control system 11, which is an element for determining the ODD, are not simply notified to the driver, but are interpreted and notified to the driver in a form that allows the driver to easily understand the necessity of taking the measure.

Note that the incentive and the penalty may not be directly given during the use period of the vehicle 1, and may be only recorded and stored for giving after the use of the automated driving.

The function update control unit 114 controls update of the function of the vehicle 1 by an update program provided by the OTA or the like. By using the OTA, even if the user does not bring the vehicle 1 to a service center or the like and does not physically connect the vehicle 1 to a communication cable or the like, a control software system of the vehicle 1 can be updated or a control parameter can be changed. As a result, function improvement and control change are realized while the user uses the vehicle 1. On the other hand, the user cannot intuitively grasp the function improvement and the control change. Therefore, because the function is changed without a step strongly acting on the memory such as depositing the vehicle 1 in the service center, for example, even if the ODD boundary condition is changed, the user does not immediately feel the sense of taking the measure.

With regard to this, the change of a responsible boundary between the vehicle control system 11 and the user caused by the OTA and the measure against the risk increased by overconfidence of the user in the vehicle control system 11 due to the influence will be described later.

FIG. 4 illustrates a configuration example of the output unit 121 included in the HMI 31.

The output unit 121 includes a display unit 131, an audio output unit 132, and a haptics device 133.

The display unit 131 includes various display devices that output various types of visual information. For example, the display unit 131 includes, for example, a digital instrument panel, a car navigation system, a digital rear mirror, a digital outer mirror, a head-up display, and the like. For example, the head-up display projects visual information on the windshield of the vehicle 1 in the vision of the driver.

For example, under the control of the output control unit 112, the display unit 131 transmits guidance information including the measure-taking method and the like to be presented to the driver by visual information.

The audio output unit 132 includes various audio output devices that output auditory information, such as a speaker, a headphone, and an earphone.

For example, under the control of the output control unit 112, the audio output unit 132 transmits the guidance information including the measure-taking method and the like to be presented to the driver by auditory information.

The haptics device 133 is a device including a haptics element, and is provided on, for example, a steering wheel, a seat, or the like, and transmits tactile information to the occupant such as the driver.

For example, under the control of the output control unit 112, the haptics device 133 transmits, by tactile information, a warning or the like that prompts the driver to take necessary measures (for example, takeover of driving, and the like).

Note that, for example, by giving a tactile stimulus (for example, an unpleasant stimulus) without using the haptics device, the driver can be also prompted to take necessary measures. For example, as such a tactile stimulus, it is assumed that the angle of the reclining seat is changed to be tilted forward, the headrest is operated, or wind is blown from the air conditioner to the face or the like of the driver.

### <Example of Sensing Areas of Vehicle 1>

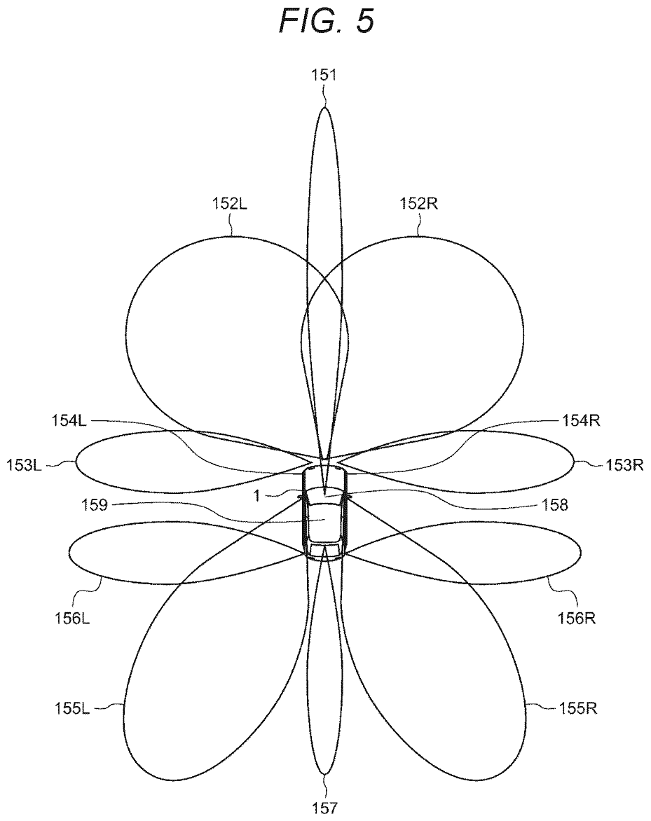

FIG. 5 is a diagram illustrating examples of sensing areas of the camera 51, the radar 52, the LiDAR 53, the ultrasonic sensor 54, and the like of the external recognition sensor 25 in FIG. 2.

A sensing area 151 is an area extending far in a narrow range in front of the vehicle 1. The sensing result in the sensing area 151 is used, for example, for monitoring or the like in front of the vehicle 1. The sensing area 151 is a particularly important sensing area, for example, in control of the vehicle 1 on an expressway or the like where high-speed traveling is performed and a curve is gentle.

A sensing area 152L is an area extending diagonally forward to the left of the vehicle 1 in a range closer than the sensing area 151. The sensing result in the sensing area 152L is used, for example, for controlling a left turn of the vehicle 1.

A sensing area 152R is an area extending diagonally forward to the right of the vehicle 1 in a range closer than the sensing area 151. The sensing result in the sensing area 152R is used, for example, for controlling a right turn of the vehicle 1 or the like.

The sensing area 152L and the sensing area 152R are sensing areas in which, for example, an approaching object such as a vehicle approaching from the left or right needs to be detected when the vehicle 1 is in an intersection, a narrow parking lot, or the like, making a gradual progress, and about to cross an oncoming road. The sensing area 152L and the sensing area 152R are important sensing areas for, for example, a device that detects a pedestrian, a bicycle, a two-wheeled vehicle, or the like crossing a road, in performing the left turn and right turn control of the vehicle 1. The sensing area 152L and the sensing area 152R are important sensing areas in a case where, for example, the vehicle passes a section such as a roundabout having a short radius of curvature.

A sensing area 153L is an area extending leftward from the front end of the vehicle 1. The sensing result in the sensing area 153L is used, for example, for detecting a vehicle or the like approaching from the left in a case where the vehicle 1 enters an intersection, a T-junction, or the like.

A sensing area 153R is an area extending rightward from the front end of the vehicle 1. The sensing result in the sensing area 153R is used, for example, for detecting a vehicle or the like approaching from the right in a case where the vehicle 1 enters an intersection, a T-junction, or the like.

Although not illustrated, a sensing area 154L is an area around the left front end of the vehicle 1. The sensing result in the sensing area 154L is used, for example, for detecting an obstacle around the left front end of the vehicle 1 and detecting a distance to the obstacle. The detection result is used, for example, at the time of parallel parking or the like.

Although not illustrated, a sensing area 154R is an area around the right front end of the vehicle 1. The sensing result in the sensing area 154R is used, for example, for detecting an obstacle around the right front end of the vehicle 1 and detecting a distance to the obstacle. The detection result is used, for example, at the time of parallel parking or the like.

A sensing area 155L is a region extending diagonally rearward to the left of the vehicle 1. The sensing result in the sensing area 155L is used, for example, for detecting an approach of the following vehicle, detecting an inter-vehicle distance from the following vehicle, detecting a case where the vehicle returns to the original lane after overtaking, detecting subsequent processing at the time of entering a merging point, and the like.

The sensing area 155L is a region extending diagonally rearward on the right of the vehicle 1. The sensing result in the sensing area 155R is used, for example, for detecting an approach of the following vehicle, detecting an inter-vehicle distance from the following vehicle, detecting subsequent processing at the time of changing a lane or entering a merging point, and the like.

A sensing area 156L is an area extending leftward from the rear end of the vehicle 1. The sensing result in the sensing area 156L is used, for example, for detecting an obstacle in the case of reversing during parking or the like.

A sensing area 156R is an area extending rightward from the rear end of the vehicle 1. The sensing result in the sensing area 156R is used, for example, for detecting an obstacle in the case of reversing during parking or the like.

A sensing area 157 is a region extending rearward of the vehicle 1. The sensing result in the sensing area 157 is used, for example, for detecting an approach of the following vehicle, the inter-vehicle distance, or the like. Although it seems that the following vehicle does not directly affect the travel of the vehicle 1, the rapid deceleration of the vehicle 1 causes a rear-end collision or a traffic jam. Furthermore, when the vehicle 1 stops on a narrow road, there is a risk of blocking social transportation infrastructure. Therefore, the sensing area behind the vehicle 1 needs to be monitored and the result needs to be reflected in the control of the vehicle 1.

A sensing area 158 is an area including the face of the driver inside the vehicle. The sensing result in the sensing area 158 is used, for example, for detecting the direction of the face of the driver, the line-of-sight direction, the wakefulness level, and the like.

A sensing area 159 is an area including the upper body of the driver inside the vehicle. The sensing result in the sensing area 159 is used, for example, for detecting a posture, a moving position, positioning, and the like of the driver.

The sensing areas described above are an example. Furthermore, there are cases where the sensing areas is complemented with each other and used, or may be used alone.

Moreover, a range of each sensing area changes due to dirt, temporal change, temporal deterioration, or the like of each sensor of the external recognition sensor 25. As the range of each sensing area changes, the travel environment condition changes, and thus, the applicable automated driving level changes in some cases. As a result, in some cases, a section to which the automated driving level planned before traveling cannot be applied occurs, and the driver needs to take measures such as the manual driving.

### <Example of Information Generated at Design and Development Stage>

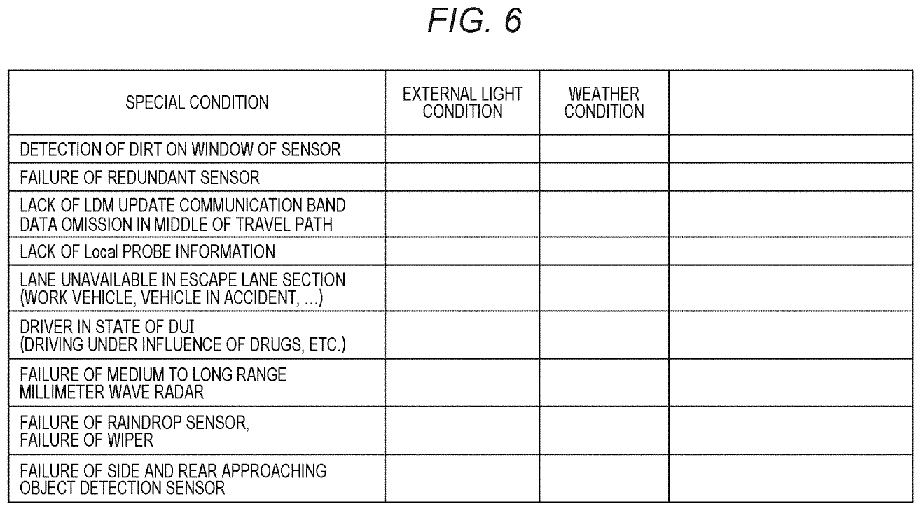

Next, an example of information generated at the design development stage of the vehicle control system 11 will be described with reference to FIGS. 6 to 8.

As described above, in the design development stage of the vehicle control system 11, the ODD verification test is performed.

Then, for example, in a case where the vehicle 1 can apply each of the automated driving levels at level 4 or lower, a condition for determining the applicable automated driving level is required.

For example, in the case of the automated driving level at level 1, only a lane keeping assistance (LKA) device and an adaptive cruise control (ACC) device are used to perform the travel assistance, and thus, a section where a dividing line can be accurately detected on an expressway, a case where a vehicle ahead is stably traveling within a legal speed on an expressway, and the like are defined as the ODD.

With regard to this, in the automated driving level at level 1, even if the boundary of the ODD is ambiguous, continuous intervention by the driver is always expected. Therefore, even if the driver cannot recognize that the travel environment condition deviates from the ODD, no major safety problem occurs.

On the other hand, in a case of the automated driving level at level 2 or higher, advanced driving assistance is provided, and there is a possibility that the driver neglects continuous surrounding monitoring physically or mentally. Therefore, applicability of the ODD greatly affects whether or not the vehicle 1 can be used safely. Therefore, if the driver does not make a correct use determination and decelerates or stops at a road shoulder without responding to a measure-taking request (for example, Take Over Request requesting takeover from the automated driving to the manual driving) required from the vehicle control system 11, due to a delay in taking a measure to return to the manual driving, for example, the own vehicle becomes the only one that disturbs the flow among a group of vehicles stably traveling at high speed, and there is a risk that particularly the following vehicle is exposed to danger.

Therefore, when the automated driving level becomes level 2 or higher, it is necessary to determine the ODD which is the boundary for switching the automated driving level and notify the driver in advance of information indicating the necessity of appropriate takeover.

With regard to this, the LUT, which is a table in which the ODD is converted into data, is generated as a condition group serving as a reference of the ODD corresponding to each of the automated driving function determined by a series of various conditions determined by design, manufacture, and authentication of the vehicle 1. Specifically, the LUT is data obtained by tabulating patterns of travel environment conditions under which a test has been performed in the ODD verification test. For example, the LUT indicates a combination of control points of the travel environment conditions under which the verification test has been performed, and availability, constraint conditions, and the like of the automated driving at each level for each combination of the travel environment conditions.

FIG. 6 illustrates a simplified example of the LUT.

The LUT in FIG. 6 includes a special condition, an external light condition, and a weather condition.

The special condition indicates a special travel environment condition which has become a target of the verification test.

The external light condition indicates, for example, a condition regarding external light (for example, direct sunlight, headlights of oncoming vehicles, and the like) emitted from the outside of the vehicle 1 to the inside of the vehicle or to the surroundings of the vehicle 1.

For example, a condition of visibility in front of the vehicle 1 is defined by a combination of the external light condition and the weather condition. For example, the conditions are classified into a state of good weather with no backlight, a state of heavy rain with a visibility of within a range of 0 to 100 m, a state of heavy rain with a visibility of within a range of 0 to 200 m, a state of rainy weather with a presence of backlight from oncoming vehicle in an urban area, a state of snowstorm with a visibility of within a range of 0 to 80 m, a state of snowstorm with a visibility within a range of 0 to 150 m, and the like.

Then, for example, availability, constraint conditions, and the like of automated driving at each level are indicated for each combination of the special condition, the external light condition, and the weather condition.

For example, in actual operation, dirt on the window of a sensor is indexed as a result of diagnosis, and availability of the automated driving level, the constraint condition, and the like are required in combination with the special condition, the external light condition, and the weather condition. For example, in a case where a degree of dirt on the window of the sensor is light, and in a case of the external light condition being cloudy and in a road section not receiving the light of the headlight of the oncoming vehicle at night, it is determined that there is no problem in the automated driving at level 4. On the other hand, it is determined that the automated driving at level 4 cannot be performed under the condition that flare occurs due to direct sunlight.

Note that the ODD may be converted into data by a method other than the LUT. For example, the ODD may be converted into data using a control formula and a coefficient.

Furthermore, a control matrix is generated on the basis of the LUT.

The control matrix is software including a function of deriving the automated driving level and the constraint condition that is applicable by the vehicle 1 with respect to a pattern of the travel environment condition not defined in the LUT. For example, the control matrix includes a program, a parameter, and the like for deriving an automated driving level and a constraint condition applicable to the pattern of the target travel environmental condition on the basis of a boundary condition and the like of each travel environment condition indicated by the LUT.

Here, the boundary condition is a condition indicating a boundary of each travel environment condition included in the ODD. For example, the boundary condition includes a lower limit value, an upper limit value, and the like of each travel environment condition. A range of the ODD is defined by the boundary condition of each travel environment condition.

The reason of defining the range of the ODD by the boundary condition is that it is not realistic to perform the verification test on all detailed combinations of the travel environment conditions, and in addition, it is redundant to convert all change indexes defined by the travel environment conditions into data and operate the data, and there is a lot of waste of resources.

Note that a driving mode is defined by a combination of the automated driving level applicable to the vehicle 1 and the constraint condition.

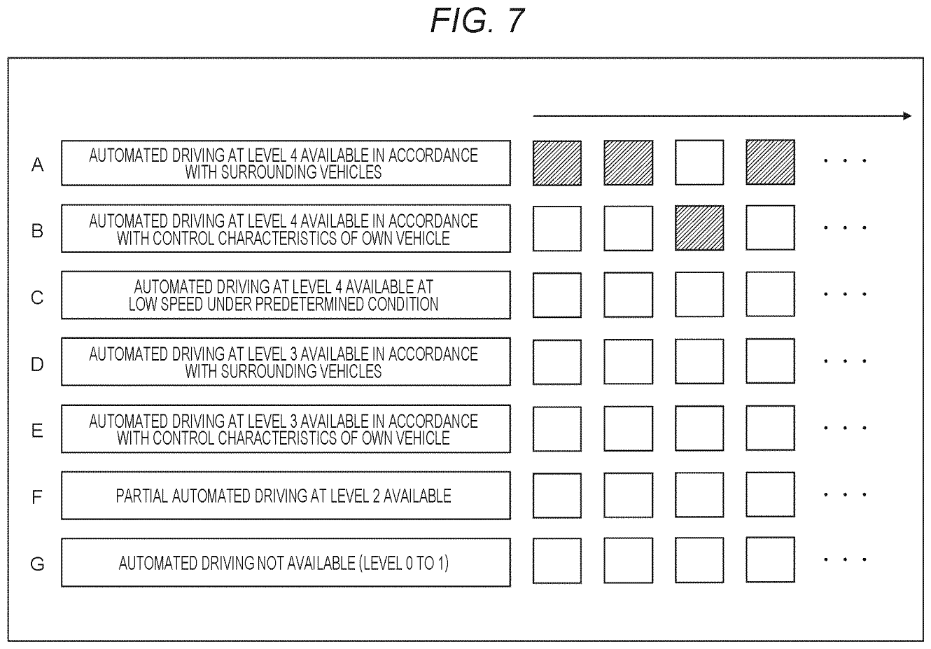

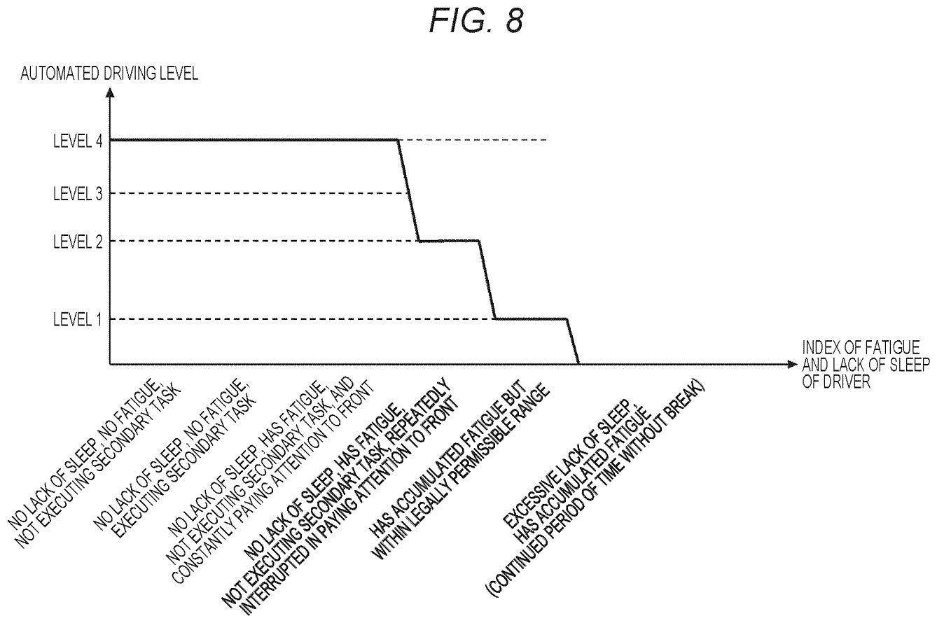

FIG. 7 illustrates an example of the driving mode of the vehicle 1. In this example, the driving mode is classified into eight modes, which are modes A to G.

The driving mode A is a mode in which the automated driving at level 4 can be performed in accordance with surrounding vehicles. That is, the mode A is a mode in which the vehicle 1 can perform automated driving in accordance with the movement of the surrounding vehicles and a response from the driver is unnecessary.

The driving mode B is a mode in which the automated driving at level 4 can be performed in accordance with control characteristics of the own vehicle. That is, the mode B is a mode in which the vehicle 1 can perform automated driving in accordance with the control characteristics of the own vehicle and a response from the driver is unnecessary. However, there is a case where the vehicle 1 cannot follow the movement of surrounding vehicles due to restriction of control characteristics due to a defect or the like.

As a case where the driving mode B is applied, for example, a case is assumed where the recognition performance of the external environment falls below the performance necessary for traveling at the maximum speed allowed in the corresponding section due to the dirt of the sensor illustrated in FIG. 6. Furthermore, for example, in a case where the weather condition gets worse due to the occurrence of fog or the like, a case is assumed where the traveling speed needs to be suppressed due to a failure of an infrared sensor or the like used complementarily for recognizing the external environment.

The driving mode C is a mode in which the automated driving at level 4 can be performed at low speed under a predetermined condition. That is, the mode C is a mode in which the vehicle 1 can perform automated driving at low speed under the predetermined condition and a response from the driver is unnecessary. The predetermined condition is assumed to be, for example, a situation or the like in which the visibility of the front can be sufficiently ensured by the headlight in a midnight time zone in which the traffic volume is extremely small. Furthermore, the low speed is in, for example, a speed range assuming a measure taken to stop at a speed slower than the legal speed.

In viewing the vehicle 1 alone, safety is ensured by applying the driving mode C. However, for example, on a highway on which high-speed traveling is required, a road on which a stopping zone is not provided along the side of the road, or the like, there are cases where the vehicle disturbs the flow of surrounding vehicles. Furthermore, for example, in a section where the visibility in the front is limited, there is a risk that a situation occurs in which the vehicle 1 suddenly appears in front of the following vehicle and collision avoidance is difficult.

The driving mode D is a mode in which the automated driving at level 3 can be performed in accordance with surrounding vehicles. That is, the mode C is a mode in which there is a case where the vehicle 1 can perform automated driving in accordance with the movement of the surrounding vehicles but a response from the driver is necessary.

However, as a condition for applying the driving mode D, it is necessary for the driver to be awakened and ready for returning to such an extent that the manual driving can be performed or to recognize a situation necessary for Situation Awareness, and in a case where this condition is not satisfied, the driving mode D cannot be applied.

The driving mode E is a mode in which the automated driving at level 3 can be performed in accordance with control characteristics of the own vehicle. That is, the mode E is a mode in which there is a case where the vehicle 1 can perform automated driving in accordance with the control characteristics of the own vehicle but a response from the driver is necessary. However, there is a case where the vehicle 1 cannot follow the movement of surrounding vehicles due to restriction of control characteristics due to a defect or the like.

The driving mode F is a mode in which the automated driving at level 2 for performing partial driving assistance such as the ACC and the LKA is possible.

In the driving mode F, because the vehicle control system 11 does not guarantee to achieve the travel control necessary for safe traveling, the driver needs to appropriately perform the operation necessary for the travel control.

The driving mode G is a mode in which the automated driving cannot be performed. That is, the mode G is a mode that corresponds to the automated driving level at level 1 or level 0.

For example, by using the control matrix, determination processing as to whether or not it is possible to actually travel at an automated driving level set in advance in each section of the destination is executed on the basis of pre-acquired information along the travel route, a self-diagnosis result of the vehicle 1, an evaluation result of the condition of the driver, and the like, and a driving mode to be applied to each section of the planned path is determined on the basis of the travel environment condition, selection of the measure-taking method by the driver, and the like.

As described above, the verification test cannot be performed on all the patterns corresponding to changes in the travel environment conditions included in the ODD. Therefore, while the vehicle 1 is traveling, there is a case where a pattern of the travel environment condition that is not defined in the LUT, that is, a pattern of the travel environment condition for which the verification test has not been performed (hereinafter, referred to as an unverified pattern) occurs.

With regard to this, for example, the control matrix is used to calculate a safe control region from verified discrete control points. For example, the control matrix derives the automated driving mode and the constraint condition applicable to the unverified pattern by extrapolating the unverified pattern to a space of the travel environmental condition formed by a pattern (hereinafter, referred to as a verified pattern) of the verified travel environment condition defined in the LUT. In this case, for example, the extrapolation of the unverified pattern is performed on the basis of the pattern distributed further on a safe side in the space under the travel environment condition.

Note that, the safe side described here includes two aspects, which are safety of the own vehicle and safety of the surroundings. For example, when the own vehicle makes an emergency stop on a road shoulder or the like with priority given to safety of the own vehicle, there are cases where the following vehicle needs to make an emergency stop or collides in the worst case. Furthermore, for example, there is a case of causing a traffic jam. Therefore, the extrapolation of the unverified pattern is performed with respect to the space under the travel environment condition so that not only the safety of the own vehicle but also the safety of the surroundings can be ensured.

Note that the above processing does not necessarily need to be implemented by programming, and may be implemented by, for example, advanced machine learning such as artificial intelligence.

FIG. 8 is a diagram illustrating an example of a function of the control matrix.

FIG. 8 is a graph schematically illustrating a function of the control matrix for deriving an applicable automated driving level on the basis of an index of fatigue and lack of sleep of the driver.

The horizontal axis in FIG. 8 indicates the index of fatigue and lack of sleep of the driver, and the degree of fatigue and lack of sleep of the driver becomes heavier as the axis advances rightward. The vertical axis indicates the applicable automated driving level.

For example, in a case where the driver has no lack of sleep, has no fatigue, and is not executing a secondary task, the automated driving level at level 4 or lower can be applied.

For example, in a case where the driver has no lack of sleep, has no fatigue, and is executing the secondary task, the automated driving level at level 4 or lower can be applied.

For example, in a case where the driver has no lack of sleep, has fatigue, is not executing the secondary task, and is constantly paying attention to the front, the automated driving level at level 4 or lower can be applied.

For example, in a case where the driver has no lack of sleep, has fatigue, is not executing the secondary task, and is in a state of being repeatedly interrupted in paying attention to the front, the automated driving level at level 2 or lower can be applied. Although this seems to be contradictory at a glance when considering the function of the automated driving, if the function of the automated driving is operated on the premise that the function of the automated driving is provided for the support of the driver, the driver becomes overconfident that an accident will not occur even if the driver performs a task of paying attention, and becomes careless. As a result, there is a risk that the possibility of occurrence of an accident increases. With regard to this, in a case where the driver is in a state of being repeatedly interrupted in paying attention, by limiting the applicable automated driving level to level 2 or lower at which the driver being interrupted in paying attention directly leads to an accident, the driver is forced to pay attention, and the awareness for the task of paying attention is improved.

For example, in a case where the driver has accumulated fatigue but the degree thereof is within a legally permissible range, the automated driving level at Level 1 or less can be applied.

For example, in a case where the driver has excessive lack of sleep and accumulated fatigue, for example, in a case where a state of not taking a break is continuing for a long time, driving is not permitted.

Note that, for example, even in a vehicle adopting the same vehicle type or the same vehicle control system, a difference in performance, safety, or the like occurs due to a difference in model or specification. As the difference in model, specification, and the like, for example, the weight of a vehicle body, the type of tires, the number of doors, whether or not a cold district specification is adopted, whether or not a measure against a salt damage is taken, the specification of a suspension, the specification of the HMI, whether or not the HUD is mounted, whether or not a fog lamp is mounted, and the like are assumed. Furthermore, in the case of commercial vehicles, after towing vehicles are manufactured alone, there are cases where equipment such as a bus, a fire engine, a ladder vehicle, and an emergency vehicle are assembled in a vehicle body manufacturer, and the vehicles are finished into different types of completed vehicles. Moreover, for example, in some cases, tuning is different for each vehicle.

With regard to this, it is difficult to perform the verification test for each ODD of the automated driving provided for all the models and the patterns of the specifications.

Therefore, the verification test of the ODD may be performed only on the vehicle of the representative model and specification, and the LUT and the control matrix for the vehicle of the representative model and specification may be generated on the basis of the result. Then, the LUT and the control matrix adjusted on the basis of the difference from the vehicle on which the verification test is performed may be applied to vehicles of different models and patterns of specifications.

For example, this adjusted control matrix may be mounted on the vehicle in advance before sale, or may be provided after sale by using the OTA or the like.

Furthermore, after the vehicle 1 is sold, there are cases where the control matrix is updated in response to a change in the boundary condition of the applied ODD by a further verification test, an update of the software of the vehicle control system 11, or the like. The updated control matrix is provided to the vehicle 1 by, for example, the OTA.

### <Specific Example of Measure-Taking Method>

Next, a specific example of the measure-taking method presented to the driver before or during traveling will be described.

As described later, in the vehicle 1, the measure-taking method for the automated driving restricted section is presented to the driver as necessary. In response, the driver selects the presented measure-taking method. The vehicle 1 determines a driving mode and a path to be applied on the basis of the selected measure-taking method, and travels according to the determination. Furthermore, the driver appropriately executes a required measure according to the selected measure-taking method.

Here, as the measure-taking method be presented, for example, the following is assumed.
Limit the traveling speed (reduce the traveling speed).
Lower the automated driving level.
Increase the inter-vehicle distance.
Switch to the manual driving.
Change the path.
For example, travel on a detour.
Evacuate to the nearest evacuation place, service area, etc.
Make emergency evacuation.
Perform maintenance (for example, repair, component replacement, inspection, etc.) of the vehicle 1.
Hand over the driving to a remote operator.
Follow a leading vehicle.

Here, a specific example of the measure-taking method presented to the driver according to the situation will be described.

For example, in a case where the windshield becomes dirty in the field of view of a front camera that captures an image of the front of the vehicle 1 through the windshield, the image quality of the front image captured by the front camera is deteriorated. When the image quality of the front image deteriorates, recognition performance (hereinafter, referred to as front recognition performance) of the situation in front of the vehicle 1 deteriorates.

Here, a degree of deterioration in the front recognition performance varies depending on the cause and degree of dirt of the windshield, the conditions of external light, and the like.

For example, there are various causes of the dirt on the windshield, such as dust blown up from a dry road surface, splash of muddy water splashing up from a wet road surface, remnants of insects that collide the vehicle while traveling, and bird droppings. The degree of dirt of the windshield also varies depending on the above-described causes and the like.

For example, in a case where only fine particles contained in dust or mud adhere to the windshield in the field of view of the front camera, the front recognition performance is hardly deteriorated unless the windshield is irradiated with direct sunlight. Therefore, in a case where the vehicle 1 is executing the automated driving at level 4, the automated driving can be continued as it is. Furthermore, because it is not necessary to urgently clean the dirt on the windshield, the measure-taking method is not necessarily presented to the driver.

On the other hand, in a case where the windshield is directly irradiated with direct sunlight, light scattering due to the direct sunlight occurs due to the fine particles adhered to the windshield, and flare occurs in the front image.

In a case where the front of the vehicle 1 is bright, the influence of flare is small, and the front recognition performance is hardly deteriorated. On the other hand, for example, in a case where the front of the vehicle 1 is dark, the influence of flare on the dark scene in front is increased in the front image, and the front recognition performance is deteriorated. For example, in a case where the fine particles are adhered to a windshield and the windshield is directly irradiated with direct sunlight, when vehicle 1 approaches an entrance of a tunnel, recognition performance for a dark scene in the tunnel is deteriorated.

In this case, because the front recognition performance is deteriorated, it is dangerous to continue the automated driving at level 4. Therefore, for example, the following measure-taking method is assumed.
Under the monitoring of the driver, enter the tunnel by the automated driving at level 3.
Before entering the tunnel, clean the fine particles adhering to the windshield by automatic cleaning. During the automatic cleaning, perform the automated driving at level 3 under the monitoring of the driver.
Enter the tunnel by the manual driving.

On the other hand, in a case where insect remnants or bird droppings adhere to the windshield in the field of view of the front camera, the front recognition performance is significantly deteriorated. In this case, for example, the following measure-taking method is assumed.
Switch to the manual driving.
Stop the vehicle 1 to clean the windshield.

However, even if the front recognition performance by the front camera is greatly deteriorated, for example, in a straight section or a section with a gentle curve such as an expressway that is not classified as a dangerous section, there is a case where the inter-vehicle distance from the preceding vehicle can be appropriately controlled by using a millimeter wave radar, LiDAR, or the like. Furthermore, even if the front camera is not used, by using a camera monitoring system, another camera for surround view, or another sensor, there are cases where the steering control to allow safe traveling of the vehicle 1 in the lane can be performed.

Meanwhile, in many of the alternative cameras, a range irradiated by the headlight of the vehicle 1 is not included in an imaging range. Therefore, in some cases, it is difficult to continue the automated driving by using the alternative camera at night.

Therefore, for example, in a case where the vehicle is traveling in the straight section of the section with a gentle curve such as an expressway in the daytime, the following measure-taking method can be added to the options.
Continue the automated driving at level 4.

Therefore, for example, in a case where the vehicle is traveling in the straight section or the section with a gentle curve such as an expressway at nighttime, the measure-taking method of continuing the automated driving at level 4 cannot be taken.

As described above, even if the windshield becomes dirty, the applicable measure-taking method varies depending on the degree of dirt, the surrounding environment, the situation of the road on which the vehicle is traveling, and the like.

Note that, as an index indicating the degree of scattered light due to the dirt on the windshield, there is a haze value. In addition, the haze value can be used as a measure of necessity of cleaning the windshield.

For example, in a case where the haze value is a predetermined threshold (for example, 5%) or more, it is determined that the windshield needs to be cleaned, and in a case where the haze value is less than the predetermined threshold, it is determined that the windshield does not need to be cleaned. Furthermore, in a case where cleaning of the windshield is selected as the measure-taking method, for example, after the windshield is cleaned, the haze value needs to be less than a predetermined threshold value.

Furthermore, for example, a case is assumed in which the image sensor of the front camera becomes high temperature due to the blazing sun while the vehicle is stopped, noise is generated in the front image, and the front recognition performance is deteriorated. In this case, it is not very desirable that the vehicle stand by while being stopped until the performance of the front camera (image sensor) is recovered. In this case, for example, the following measure-taking method is assumed.
Until the performance of the image sensor is recovered, reduce the speed to such an extent that safety can be ensured in a state where the front recognition performance is deteriorated, and perform the automated driving at level 4.
Until the performance of the image sensor recovers, perform the automated driving at level 3 at a normal speed under the monitoring of the driver.

Furthermore, for example, in a case where air pressure of the tires of the vehicle 1 is low and in a case where only the urban area is included in the planned path, an emergency measure does not need to be taken, and thus, the measure-taking method is not necessarily presented to the driver. On the other hand, in a case where an expressway is included in the planned path, there is a possibility that a burst of the tire occurs, and thus, for example, adjustment of the air pressure of the tire is presented to the driver as the measure-taking method before departure.

Furthermore, for example, in a case where a user, who has difficulty in performing the manual driving due to illness, is driving in the automated vehicle to the nearest medical facility in a hurry because there is difficulty in arranging an emergency vehicle, priority is given to arriving at the medical facility by the automated driving. Meanwhile, the manual driving cannot be expected to be performed by the user.

In this case, for example, continuation of the automated driving is presented to the driver as the measure-taking method even if the deceleration or making a detour is required. Meanwhile, the measure-taking method for passing the section by the manual driving is not presented to the driver.

On the other hand, for example, in a case where the driver is simply operating a smartphone or the like while the automated driving is operating normally, it is desirable to travel at high speed by the manual driving rather than decelerating and continuing the automated driving or waiting in a service area or the like until the travel environment is improved. Furthermore, because a short specific section to which the automated driving cannot be applied is included, there are cases where it is undesirable to avoid a long section including the specific section and travel by the automated driving on a detour that can be passed only at low speed.

In this case, for example, the measure-taking method of passing the specific section by the manual driving is preferentially presented to the driver.

As described above, the appropriate target method varies depending on the situation (difference in travel environment conditions).

With regard to this, the action planning unit 62 derives the automated driving level and the constraint condition applicable in each section on the basis of the travel environment condition in the travel plan on the basis of the control matrix. Furthermore, the action planning unit 62 creates and presents the measure-taking method to be presented to the driver as necessary on the basis of the automated driving level and the constraint condition applicable in each section.

Then, the action planning unit 62 changes the travel plan as necessary on the basis of the measure-taking method selected by the driver. That is, the action planning unit 62 changes the path or changes the driving mode to be applied in each section as necessary.

As described above, the applicable automated driving level and the constraint condition are determined not only by the above factors requiring the measures taken on the road side, but also by combinations of various conditions.

### <Automated Driving Control Processing>

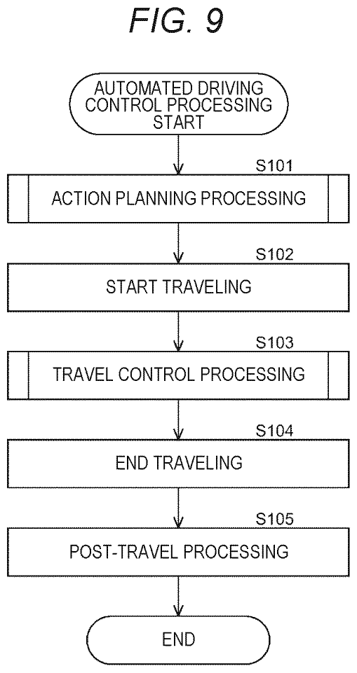

Next, automated driving control processing executed by the vehicle 1 in FIG. 5 will be described with reference to a flowchart in FIG. 9.

In step S101, the vehicle control system 11 executes action planning processing.

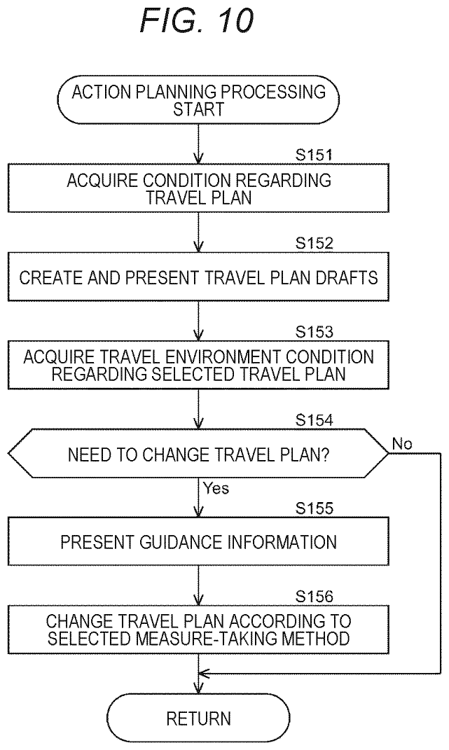

Here, details of the action planning processing will be described with reference to a flowchart in FIG. 10.

In step S151, the vehicle control system 11 acquires a condition regarding the travel plan. For example, the vehicle control system 11 acquires information such as a departure place, a destination, a departure date and time, a desired arrival date and time, and a user preference as the condition regarding the travel plan.

The user preference indicates a preference of the user with respect to the travel plan and a priority order of necessary measures. For example, the user preference includes items such as time priority, automated driving priority, manual driving priority, toll road priority, and toll-free road priority.

In a case where the time priority is selected, the travel plan is created with priority given to shortening the required time to the destination. Therefore, for example, there is a possibility that the number of sections presented to perform the manual driving increases in a case where it is difficult to travel by the automated driving at the legal speed limit in order to ensure safety due to restriction of recognition performance of the device or the like.

In a case where the automated driving priority is selected, the travel plan is created with priority given to selecting a path on which the automated driving can be performed. Therefore, for example, by traveling via a detour or traveling at low speed, the required time possibly increases.

In a case where manual driving unacceptable is selected, the travel plan is created while only a path on which the automated driving can be performed is selected. Note that, for example, it is also assumed that the user contracts with a lead and traction service for performing following traveling by electronic traction by electronic pairing, and receives provision of the lead and traction service in a section where the vehicle 1 is difficult to pass by the automated driving.

In a case where the toll road priority is selected, the toll road is preferentially selected in creating the travel plan.

In a case where the toll-free road priority is selected, the toll-free road is preferentially selected in creating the travel plan, within a range allowing the vehicle to arrive at the destination on the desired arrival date and time. Note that a plurality of items may be selected in combination in the user preference.

Note that a method of acquiring the condition regarding the travel plan is not particularly limited.

For example, the driver may input the condition regarding the travel plan by using the HMI 31. The HMI 31 supplies information indicating the condition regarding the travel plan input by the driver to the action planning unit 62.

For example, the action planning unit 62 may receive, via the communication unit 22, information regarding a schedule registered by the driver in a smartphone or the like, and extract the condition regarding the travel plan from the received information. Furthermore, for example, a priority option suitable for the driver may be provided by using a concierge service or the like.

In step S152, the vehicle control system 11 creates and presents travel plan drafts.

Specifically, for example, the action planning unit 62 searches for a path connecting the departure place and the destination. The action planning unit 62 creates the travel plan drafts by setting the automated driving level in each path by using the control matrix on the basis of the global ODD without referring to the detailed travel environment condition of each path.

The action planning unit 62 sets the priority order of the created travel plan drafts on the basis of the user preference. For example, in a case where the time priority is selected as the user preference, the priority order of the travel plan drafts is set on the basis of the required time. For example, in a case where the automated driving priority is selected as the user preference, the priority order of the travel plan drafts is set on the basis of the ratio of the section to which the automated driving can be applied. For example, in a case where the manual driving unacceptable is selected as the user preference, the travel plan draft that allows traveling only by the automated driving is selected.

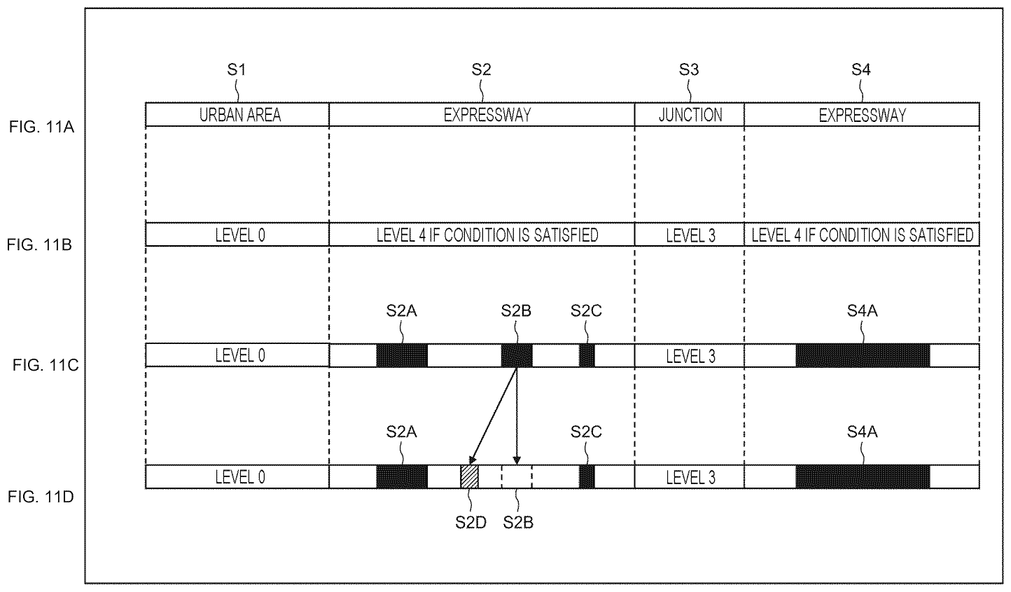

FIG. 11 illustrates an example of the travel plan draft.

For example, as illustrated in A of FIG. 11, a path from the departure place to the destination is divided into section S1 to section S4 without considering detailed travel environment conditions. The section S1 is a section of traveling in an urban area. The section S2 is an expressway. The section S3 is a junction of an expressway. The section S4 is an expressway.

Next, as illustrated in B of FIG. 11, the automated driving level of each section is set on the basis of an ideal condition under which no special travel environment condition occurs. For example, the automated driving level in the section S1 is set to level 0. The automated driving level in the section S2 is set to level 4. The automated driving level in the section S3 is set to level 3. The automated driving level in the section S4 is set to level 4.

In this way, the travel plan draft as illustrated in B of FIG. 11 is created.

The display unit 131 presents the created travel plan drafts to the driver under the control of the output control unit 112.

In step S153, the vehicle control system 11 acquires the travel environment condition regarding the selected travel plan.

For example, the driver selects a desired travel plan from the presented travel plan drafts, and inputs a selection result of the travel plan by using the HMI 31.

Note that, in a case where the driver does not select the travel plan, for example, the travel plan with the highest priority is automatically selected.

In response to this, the HMI 31 supplies information indicating the selection result of the travel plan to the action planning unit 62 and the travel environment condition acquisition unit 111.

The travel environment condition acquisition unit 111 acquires the travel environment condition regarding the selected travel plan.

For example, the travel environment condition acquisition unit 111 communicates with various devices inside and outside the vehicle, other vehicles, servers, base stations, and the like via the communication unit 22, and acquires information regarding the travel environment condition around the planned path in the selected travel plan. For example, the travel environment condition acquisition unit 111 acquires information regarding the travel environment condition around the planned path on the basis of the map accumulated in the map information accumulation unit 23. For example, the travel environment condition acquisition unit 111 acquires a detection result or a recognition result of the situation outside the vehicle 1 from the recognition unit 73. For example, the travel environment condition acquisition unit 111 acquires the recognition result of the state of the occupant including the driver and the recognition result of the situation inside the vehicle from the DMS 30. For example, the travel environment condition acquisition unit 111 acquires a detection result of the state of each unit of the vehicle 1 from the vehicle control unit 32. For example, the travel environment condition acquisition unit 111 performs a motion diagnosis of each unit of the vehicle 1 or causes each unit of the vehicle 1 to perform the motion diagnosis and acquires the result.

The travel environment condition acquisition unit 111 supplies the acquired information regarding the travel environment condition to the action planning unit 62.

In step S154, the action planning unit 62 determines whether or not it is necessary to change the travel plan. Specifically, the action planning unit 62 reviews the travel plan selected in the processing of step S153 by using the control matrix, on the basis of the acquired travel environment condition. As a result of reviewing the travel plan, in a case where there is a section in which at least one of the path and the automated driving level needs to be changed in the selected travel plan, the action planning unit 62 determines that the travel plan needs to be changed, and the processing proceeds to step S155.

For example, C of FIG. 11 illustrates a result of reviewing the travel plan. In this example, under the current travel environment condition, it is determined that the automated driving at level 4 cannot be applied in a section S2A to a section S2C in the section S2 and a section S4A in the section S4.

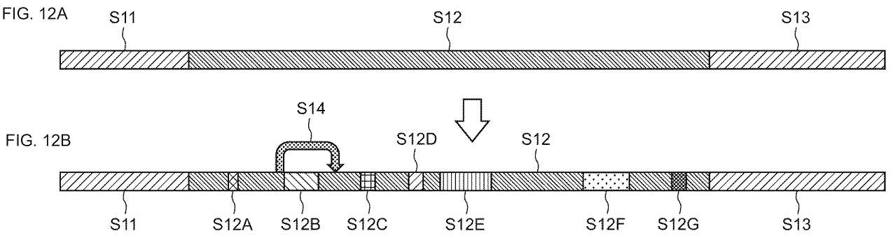

FIG. 12 illustrates another example of the result of reviewing the travel plan.

A of FIG. 12 illustrates an example of the travel plan before being reviewed.

For example, a section S11 and a section S13 are sections that the vehicle travels in an urban area, and are set to the automated driving level at level 0. A section S12 is a section of a highway that the vehicle travels in the suburb, and is set to the automated driving level at level 4.

B of FIG. 12 illustrates an example of a result of reviewing the travel plan of A of FIG. 12.

For example, a section S12A is a section of an entrance of a tunnel. As described above, there are cases where the front recognition performance of the front camera deteriorates at the entrance of the tunnel depending on the dirt on the windshield and the state of external light. Therefore, depending on the travel environment condition, there is a section in which there is a possibility that the automated driving at level 4 cannot be applied.

A section S12B is a section in which there is no road shoulder, and is a section in which evacuation cannot be performed by the MRM.

In response to this, for example, a bypass S14 for avoiding the section S12B is detected.

A section S12C is a section in which there is an exposed bridge. The section S12C is a section in which the passage by the automated driving during strong wind has not been verified, and thus, the automated driving at level 4 cannot be applied during strong wind.

A section S12D is a section in which there is an underpass, and is a section having a risk of flooding and where the passage possibly becomes difficult during heavy rain. The section S12D is a section in which the passage by the automated driving during heavy rain has not been verified, and thus, the automated driving at level 4 cannot be applied during heavy rain.

A section S12E is a section in which there is a roundabout. Therefore, the section S12E is a section where the automated driving at level 4 at the legal speed cannot be applied, if, for example, the wide-angle camera fails or the windshield becomes dirty in the field of view of the front camera.

A section S12F is a section in which the visibility is greatly reduced due to backlight depending on the season and the time zone during the day in the good weather. Therefore, the section S12F is a section to which the automated driving at level 4 at the legal speed cannot be applied depending on the weather, the season, and the time zone.

A section S12G is a section under construction, and is a section in which a traffic restriction possibly occurs. Therefore, this section is a section in which it is necessary to confirm the presence, absence, or the like of the traffic restriction of the section S12G before passing the section S12G.

In step S155, the vehicle control system 11 presents the guidance information.

Specifically, the action planning unit 62 creates the measure-taking method for a section in which the travel plan needs to be changed. The action planning unit 62 sets the priority order of the created measure-taking methods on the basis of the user preference. The action planning unit 62 supplies information indicating the created measure-taking method and priority order to the output control unit 112.

The output control unit 112 generates a selection menu in which the measure-taking method are arranged in a selectable manner according to the priority order. The output control unit 112 controls the display unit 131 to present the guidance information including the generated selection menu to the driver.

For example, in the example in FIG. 11, the guidance information including the measure-taking methods for the section S2A to the section S2C and the section S4A are presented to the driver.

For example, in the example in FIG. 12, the guidance information is presented to the driver, the guidance information including the measure-taking methods for the sections among the section S12A to the section S12G where the automated driving at level 4 with no constraint condition cannot be applied.

Note that a specific example of the selection menu included in the guidance information will be described later.

In step S156, the vehicle control system 11 changes the travel plan according to the selected measure-taking method.

For example, the driver selects a desired measure-taking method from the presented measure-taking methods, and inputs a selection result of the measure-taking method by using the HMI 31.

Note that, in a case where the driver does not select the measure-taking method, for example, the measure-taking method with the highest safety is automatically selected.

In response to this, the HMI 31 supplies information indicating the selection result of the measure-taking method to the action planning unit 62.

The action planning unit 62 changes the travel plan according to the selected measure-taking method. For example, the action planning unit 62 changes the path as necessary or changes the driving mode (automated driving level and constraint condition) applied to each section of the travel plan according to the selected measure-taking method.

For example, in the example in FIG. 11, the driving mode G in FIG. 7 is set for the section S1 and the section S4. The driving mode A is set for a section of the section S2 other than the section S2A and the section S2C and a section of the section S4 other than the section S4A. For the section S2A, the section S2B, and the section S4A, one of the driving modes among the driving mode B and the subsequent modes is set according to the selected measure-taking method.

Note that, for example, in a case where the section S2B is the entrance of the tunnel, and it is determined that the automated driving at level 4 is not applied due to the dirt on the windshield, in a case where the measure-taking method of cleaning the windshield before the section S2B is selected, the section S2B becomes an application target of the automated driving at level 4. Therefore, the driving mode A is set for the section S2B.

Thereafter, the action planning processing ends.

Meanwhile, in a case where it is determined in step S154 that the travel plan does not need to be changed, the processing of step S155 and step S156 is skipped, and the action planning processing ends.

Returning to FIG. 9, in step S102, the vehicle 1 starts traveling. Specifically, the motion control unit 63 starts processing of controlling the vehicle control unit 32 so that the vehicle 1 travels from the departure place to the destination according to the travel plan created by the action planning unit 62.

In step S103, the vehicle control system 11 executes travel control processing.

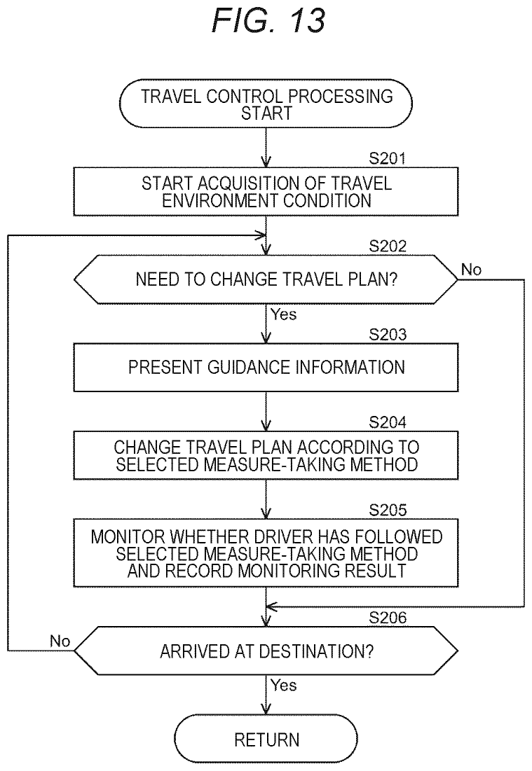

Here, details of the travel control processing will be described with reference to the flowchart in FIG. 13.

In step S201, the vehicle control system 11 starts acquisition of the travel environment condition. Specifically, the travel environment condition acquisition unit 111 acquires the travel environment condition regarding the travel plan during traveling and to be traveled by the processing similar to step S153 in FIG. 10, and starts the processing of supplying the acquired information regarding the travel environment condition to the action planning unit 62.

In step S202, similarly to the processing of step S154 in FIG. 10, it is determined whether or not the travel plan needs to be changed. In a case where it is determined that the travel plan needs to be changed, the processing proceeds to step S203.

The determination processing in step S202 is repeatedly executed until it is determined that the vehicle has arrived at the destination in the processing in step S206 to be described later. For example, on the basis of the information of self-diagnosis of devices of the vehicle 1 acquired by the travel environment condition acquisition unit 111, an availability status of the manual driving by the driver, and the like, the determination as to whether or not the automated driving at a preset level is possible in each section on the planned path is repeatedly executed. With this arrangement, there is a case where a section in which the applicable automated driving level changes appears due to an event (for example, a change in the weather, dirt on the windshield, and the like) that is not expected at the beginning of the plan.

However, in a case where the applicable automated driving level is changed due to such a variable factor, it is difficult to explicitly notify a clear index for the takeover request assumed in the conventional control concept, for example, issuing the takeover request to the manual driving because the concerned section is a construction section. That is, for example, even if an index of the amount of dirt on the windshield is notified, it is difficult for the driver to use the index as a determination material for taking appropriate measures.

In step S203, in view of the problem described above, the guidance information is presented on the basis of the newly updated condition similarly to the processing in step S155 in FIG. 10.

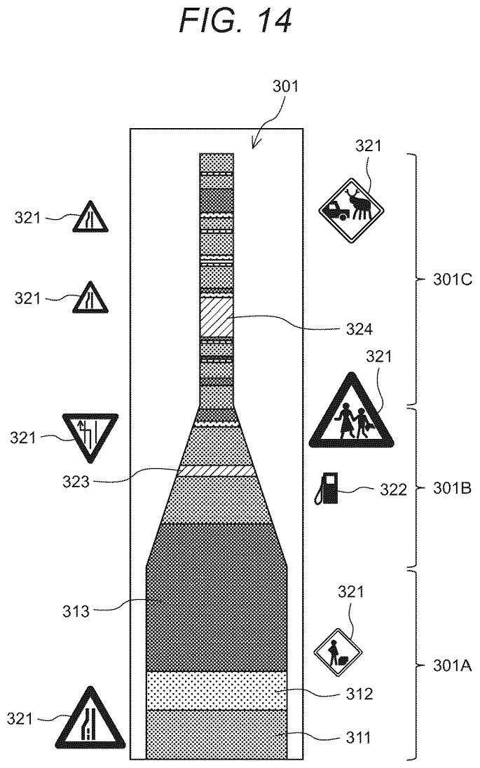

FIG. 14 is a diagram illustrating an example of the conventional guidance information 301.

In the guidance information 301, the travel plan is illustrated in a bird's-eye view, and information requiring measures to be taken is superimposed.

Specifically, the guidance information 301 indicates the advancing direction of the own vehicle from the lower end side toward the upper end side.

The guidance information 301 is divided into a short distance display part 301A, a middle distance display part 301B, and a long distance display part 301C. The short distance display part 301A displays a section from a current position in front of the own vehicle to a predetermined first distance. The middle distance display part 301B displays a section from the predetermined first distance in front of the own vehicle to a predetermined second distance. The middle distance display part 301B displays a section separated by the predetermined second distance or farther in front of the own vehicle.

In the guidance information 301, an automated driving available section 311, a return posture maintaining section 312, and a driving return required section 313 are displayed in different colors (however, in the drawing, color distinction is represented by a pattern). The automated driving available section 311 is a section in which the automated driving at level 4 is possible. The return posture maintaining section 312 is a section immediately before returning from the automated driving to the manual driving, and is a section in which the driver is desired to maintain the posture of returning to the manual driving. The driving return required section 313 is a section in which the manual driving by the driver is required.

An icons 321 is an icon representing a traffic sign, indicating parts and contents to be paid attention by the driver. An icon 322 is an icon indicating a position of various facilities such as a gas station, a parking area, and a service area. A section display 323 and a section display 324 indicate sections such as a congested section in which the time required for passing possibly greatly varies.

As described above, in the guidance information 301, information regarding a situation or a place that requires measures to be taken is presented. However, even if various travel environment conditions that change from moment to moment during traveling are presented in detail, the driver cannot always correctly understand the presented information and appropriately take measures for the presented information.

Furthermore, for example, in a conventional navigation system or the like, there is a technology of presenting information such as a closed section and a section in which traveling of a vehicle without a tire chain is prohibited due to heavy snow. However, the information to be presented is uniform for all the vehicles, and appropriate information according to the travel environment condition of each vehicle is not necessarily presented.

On the other hand, in the vehicle 1, guidance information including a specific and appropriate measure-taking method is presented to the driver.

Specifically, for example, the guidance information including the selection menu in which the measure-taking methods are arranged in the priority order is presented to the driver. The priority order of the measure-taking method is set on the basis of, for example, the user preference and the travel environment condition.

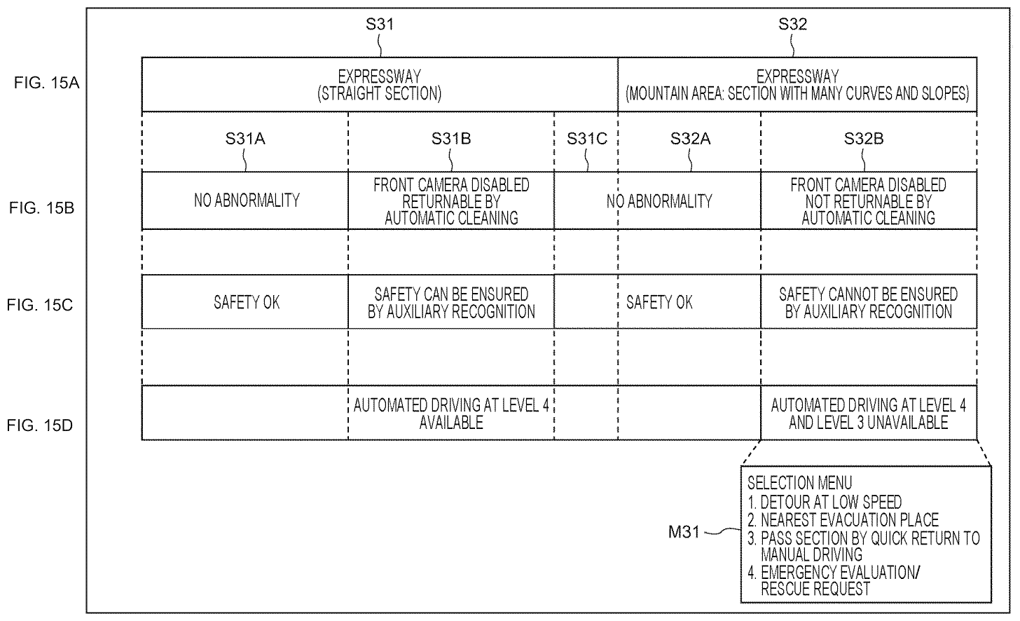

Here, specific examples of the selection menu will be described with reference to FIGS. 15 to 17.

FIG. 15 illustrates an example of a case where the front image captured by the front camera is used to recognize the situation in front of the vehicle 1, and the front camera, other cameras, a millimeter wave radar, LiDAR, and the like can cooperate to recognize the situation around the vehicle 1. The other cameras include, for example, a side camera that captures the side of the vehicle 1, a rear camera that captures the rear, and the like.

A of FIG. 15 illustrates an example of the planned path. A section S31 is a straight section of an expressway. A section S32 is a section in a mountain area of the expressway, and is a section having many curves and slopes.

B of FIG. 15 illustrates a state of the front camera.

The section S31 is divided into sections S31A to S31C on the basis of the state of the front camera.

The section S31A is a section in which no abnormality has occurred in the front camera.

The section S31B is a section in which the front camera is disabled due to the dirt on the windshield. The state in which the front camera is disabled is a state in which the image quality of the front image by the front camera is deteriorated and the front image cannot be used for the recognition processing of the situation in front of the vehicle 1. The dirt on the windshield in the section S31B can be cleaned by the automatic cleaning function of the vehicle 1, and the front camera is enabled by removing the dirt on the windshield. That is, a state is obtained in which the front image captured by the front camera can be used for the recognition processing of the situation in front of the vehicle 1.

The section S31C is a section in which the abnormality of the front camera has been eliminated by cleaning the windshield with the automatic cleaning function.

The section S32 is divided into sections S32A and S32B on the basis of the state of the front camera.

The section S32A is a section in which no abnormality has occurred in the front camera.

The section S32B is a section in which, similarly to the section S31B, the front camera is disabled due to the dirt on the windshield. However, the dirt on the windshield in the section S32B cannot be cleaned by the automatic cleaning function of the vehicle 1, and the front camera will not be enabled unless other measures are taken.

C of FIG. 15 illustrates a determination result of the safety of the vehicle 1 in each section.

Because no abnormality has occurred in the front camera in the section S31A, the section S31C, and the section S32A, these sections are determined to have no problem in safety.

The section S31B is the straight section of the expressway, and has good visibility in front of the vehicle 1. Therefore, the situation in front of the vehicle 1 can be recognized with a certain degree of accuracy by auxiliary recognition using the LiDAR 53, the side camera, the rear camera, and the like instead of the front camera. Therefore, it is determined that the safety of the vehicle 1 can be ensured even if the front camera is disabled.

On the other hand, the section S32B is the section in the mountain area of the expressway, and the visibility in front of the vehicle 1 is poor. Therefore, the accuracy in the recognition of the situation in front of the vehicle 1 deteriorates in a case where the auxiliary recognition using the LIDAR 53, the side camera, the rear camera, and the like are used instead of the front camera. Therefore, it is determined that the safety of the vehicle 1 cannot be ensured in a case where the front camera is disabled.

D of FIG. 15 illustrates the automated driving level applicable in each section.

In the sections S31A to S32A, because the safety of the vehicle 1 can be ensured, the automated driving at level 4 can be applied.

Note that, for example, in the section S31B, the driver may be notified that the vehicle is passing by using the auxiliary recognition.

On the other hand, in the section S32B, because the safety of the vehicle 1 cannot be ensured, the automated driving at level 4 and level 3 cannot be applied.

Therefore, for example, a selection menu M31 is presented to the driver for the section S32B. The selection menu M31 includes the following four measure-taking methods, and a measure-taking method at a higher position has a higher priority.
1. Detour at low speed
2. Nearest evacuation place
3. Pass the section by quick return to manual driving
4. Emergency evacuation/rescue request

“Detour at low speed” is a measure-taking method in which the vehicle travels on a detour by the automated driving at level 4 at speed at which the safety can be ensured by the auxiliary recognition.

“Nearest evacuation place” is a measure-taking method in which the vehicle evacuates to and stops at the nearest evacuation place. Then, for example, the front camera can be enabled by the driver manually cleaning the windshield of the vehicle 1 in the evacuation place. With this arrangement, the vehicle can pass the remaining section of the section S32B by the automated driving at level 4.

“Pass the section by quick return to manual driving” is a measure-taking method in which the driver returns to the manual driving quickly and passes the section S32B by the manual driving.

“Emergency evacuation/rescue request” is a measure-taking method in which the vehicle 1 is immediately evacuated to the edge of the road and a rescue service is requested.

When the driver selects a desired measure-taking method from the four measure-taking methods, the vehicle 1 executes the motion according to the selected measure-taking method. However, in a case where “Pass the section by quick return to manual driving” is selected, a response from the driver is required.

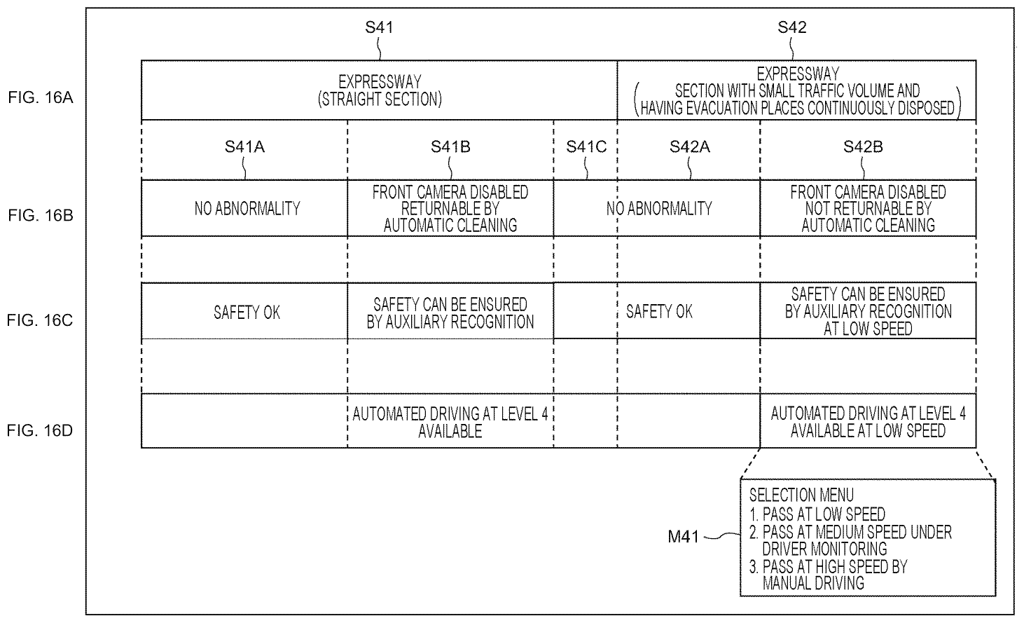

Similarly to FIG. 15, FIG. 16 illustrates an example of a case where the front image captured by the front camera is used to recognize the situation in front of the vehicle 1, and the front camera, other cameras, a millimeter wave radar, LiDAR, and the like can cooperate to recognize the situation around the vehicle 1.

A of FIG. 16 illustrates an example of the planned path. A section S41 is a straight section of an expressway. A section S42 is a section in which the traffic volume is small on the expressway and the evacuation place is continuously disposed.

B of FIG. 16 illustrates a state of the front camera. The state of the front camera in sections S41A to S42B is similar to the state of the front camera in the sections S31A to S32B in FIG. 15.

C of FIG. 16 illustrates a determination result of the safety of the vehicle 1 in each section.

Because no abnormality has occurred in the front camera in the section S41A, the section S41C, and the section S42A, these sections are determined to have no problem in safety.

In the section S41B, similarly to the section S31B in FIG. 15, it is determined that the safety of the vehicle 1 can be ensured by the auxiliary recognition even if the front camera is disabled.

Because the traffic volume is small in the section S42B, there is a low possibility of hindering the travel of other vehicles or causing a traffic jam even if the vehicle travels at low speed. Furthermore, because the evacuation places are continuously disposed, the vehicle 1 can be immediately evacuated even if a danger or a fault occurs. Therefore, it is determined that safety can be ensured by the auxiliary recognition at low speed.

D of FIG. 16 illustrates the automated driving level applicable in each section.

In the sections S41A to S42A, similarly to the sections S31A to S32A in FIG. 16, the automated driving at level 4 can be applied.

On the other hand, in the section S42B, the automated driving at level 4 can be applied under the constraint condition of low-speed traveling.

Therefore, for example, a selection menu M41 is presented to the driver for the section S42B. The selection menu M41 includes the following three measure-taking methods, and a measure-taking method at a higher position has a higher priority.
1. Pass at low speed
2. Pass at medium speed under driver monitoring
3. Pass at high speed by manual driving

“Pass at low speed” is a measure-taking method of passing the section S42B by the automated driving at level 4 at low speed.

“Pass at medium speed under driver monitoring” is a measure-taking method of passing the section S42B by the automated driving at level 3 under the monitoring by the driver.

“Pass at high speed by manual driving” is a measure-taking method of passing the section S42B at high speed by the manual driving by the driver.

When the driver selects a desired measure-taking method from the three measure-taking methods, the vehicle 1 executes the motion according to the selected measure-taking method. However, in a case where “Pass at medium speed under driver monitoring” or “Pass at high speed by manual driving” is selected, a response from the driver is required. Therefore, for example, in order to present these measure-taking methods, it is necessary for the DMS 30 to confirm in advance that the driver is in a posture ready for returning to driving and in an awake state.

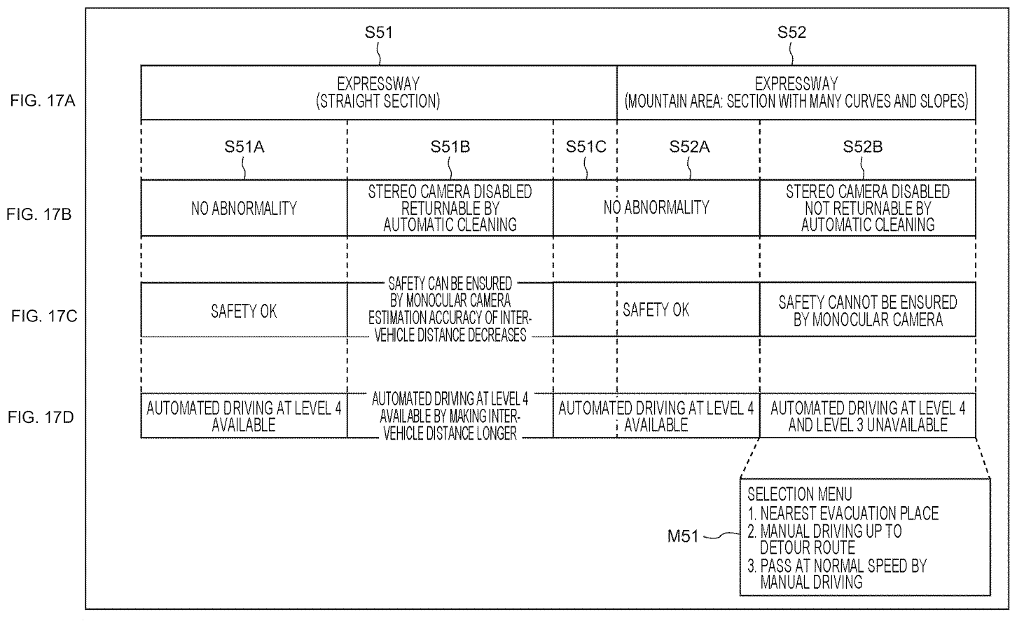

FIG. 17 illustrates an example of a case where the front image in which the front of the vehicle 1 is captured through the windshield by a stereo camera provided in the vehicle is used to recognize the situation in front of the vehicle 1, and the stereo camera, other cameras, a millimeter wave radar, LiDAR, and the like do not cooperate with each other.

A of FIG. 17 illustrates an example of the planned path. A section S51 is a straight section of an expressway. Similarly to the section S32 in FIG. 15, a section S52 is a section in a mountain area of the expressway, and is a section having many curves and slopes.

B of FIG. 17 illustrates a state of the stereo camera.

The section S51 is divided into sections S51A to S51C on the basis of the state of the stereo camera.

The section S51A is a section in which no abnormality has occurred in the stereo camera.

The section S51B is a section in which one side of the stereo camera is disabled due to the dirt on the windshield. The dirt on the windshield in the section S51B can be cleaned by the automatic cleaning function of the vehicle 1, and both sides of the stereo camera are enabled by removing the dirt on the windshield.

The section S51C is a section in which the abnormality of the stereo camera has been eliminated by cleaning the windshield with the automatic cleaning function.

The section S52 is divided into sections S52A and S52B on the basis of the state of the stereo camera.

The section S52A is a section in which no abnormality has occurred in the stereo camera.

The section S52B is a section in which one side of the stereo camera is disabled due to the dirt on the windshield. The dirt on the windshield in the section S52B cannot be cleaned by the automatic cleaning function of the vehicle 1, and the one side of the stereo camera will not be enabled unless other measures are taken.

C of FIG. 17 illustrates a determination result of the safety of the vehicle 1 in each section.

Because no abnormality has occurred in the stereo camera in the section S51A, the section S51C, and the section S52A, these sections are determined to have no problem in safety.

The section S51B is determined to be a section in which the safety of the vehicle 1 can be ensured by using the front image captured by the effective side of the camera (monocular camera). However, because the one side of the stereo cameras is disabled, it is determined that the estimation accuracy of the inter-vehicle distance with the preceding vehicle decreases.

In the section S52B, it is determined that the safety of the vehicle 1 cannot be ensured by the monocular camera.

D of FIG. 17 illustrates the automated driving level applicable in each section.

In the sections S51A, the section S51C, and the section S52A, because the safety of the vehicle 1 can be ensured, the automated driving at level 4 can be applied.

The section S51B is the straight section of the expressway, and has good visibility in front of the vehicle 1. Therefore, although the estimation accuracy of the inter-vehicle distance decreases, if the inter-vehicle distance is made longer than usual, the automated driving at level 4 can be applied.

Note that, for example, in the section S51B, the driver may be notified that the inter-vehicle distance is ensured longer than usual because the automated driving is being executed by the monocular camera.

On the other hand, in the section S52B, because the safety of the vehicle 1 cannot be ensured, the automated driving at level 4 and level 3 cannot be applied.

Therefore, for example, a selection menu M51 is presented to the driver for the section S52B. The selection menu M51 includes the following three measure-taking methods, and a measure-taking method at a higher position has a higher priority.
1. Nearest evacuation place
2. Manual driving up to detour route
3. Pass at normal speed by manual driving

“Nearest evacuation place” is a measure-taking method in which the vehicle evacuates to and stops at the nearest evacuation place. Then, for example, the stereo camera can be enabled by the driver manually cleaning the windshield of the vehicle 1 in the evacuation place. With this arrangement, the vehicle can pass the remaining section of the section S52B by the automated driving at level 4.

“Manual driving up to detour route” is a measure-taking method in which the driver manually drives up to the detour route and then passes the detour route by automated driving at level 4.

“Pass at normal speed by manual driving” is a measure-taking method of passing the section S42B at normal speed by the manual driving by the driver.

When the driver selects a desired measure-taking method from the three measure-taking methods, the vehicle 1 executes the motion according to the selected measure-taking method. However, in a case where “Manual driving up to detour route” or “Pass at normal speed by manual driving” is selected, a response from the driver is required.

Note that the timing of presenting the measure-taking method is not necessarily limited to the timing at which a situation requiring measure is detected. For example, the measure-taking method may be presented on the basis of the timing at which the vehicle is predicted to pass the automated driving restricted section affected by executing the measure based on the measure-taking method.

For example, as described above, in a case where the front recognition performance is deteriorated at the entrance of the tunnel due to the dirt on the windshield, there is a case where entering the tunnel by the automated driving at level 4 becomes available by having the windshield cleaned in advance.

However, if the windshield is cleaned too early, there is a high possibility that the windshield becomes dirty again before reaching the entrance of the tunnel. With this arrangement, for example, even though the windshield has been cleaned, there is a possibility that the vehicle cannot enter the tunnel by the automated driving at level 4, or the cleaning solution is wasted by requiring to clean the windshield again.

Therefore, for example, it is important that the selection menu including the measure-taking method of “cleaning the windshield” is presented to the driver at the appropriate timing before entering the tunnel.

For example, in a case where the automatic cleaning can be performed, it is desirable that the guidance information including the selection menu is presented at a point close to the entrance of the tunnel. For example, in a case where the manual cleaning can be performed, the guidance information including the selection menu is desirably presented at a point close to the entrance of the tunnel and just before a place that the vehicle can stop.

Here, “just before” is not a point immediately before the place where the vehicle can stop, but is a point in consideration of the timing at which a sufficient time required for the driver to take a measure can be secured.

For example, in a case of detecting the dirt on the windshield that is strongly adhered and difficult to remove even if the windshield is cleaned while traveling, a point at which the guidance information is to be presented is selected from the following points according to the situation.
A point where the manual cleaning can be performed is sufficiently secured until arrival at the entrance of the tunnel in consideration of a case where the manual cleaning is required
A point where the driver can normally return to the manual driving until the vehicle arrives at the entrance of the tunnel in a case where the cleaning is not successful and the driver is requested to return to the manual driving and even if there is a delay in the subsequent measure to be taken
A point where selection of detour can be secured to a route that enables safe traveling by the automated driving before arrival at the tunnel even if the driver is not successful in returning to the manual driving

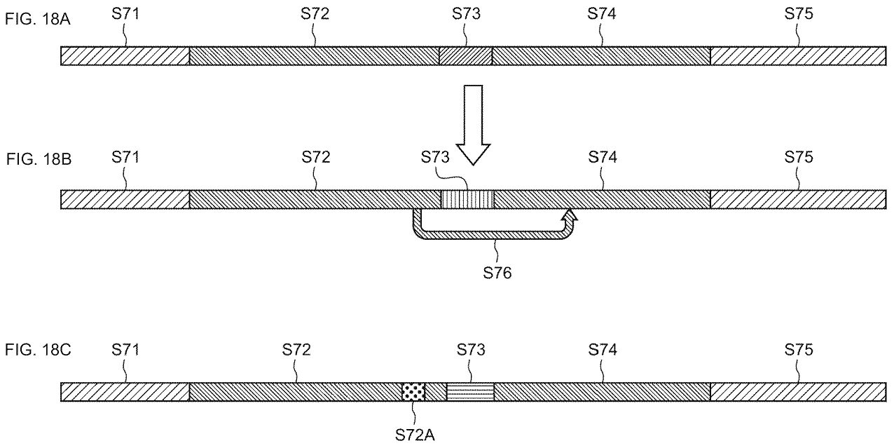

Here, another example regarding the timing of presenting the measure-taking method will be described with reference to FIG. 18.

A of FIG. 18 illustrates an example of the travel plan before the abnormality occurs in the vehicle 1.

For example, a section S71 and a section S75 are sections that the vehicle travels in an urban area, and are set to the automated driving level at level 0. Sections S72 to S74 are sections of a highway that the vehicle travels in the suburb, and are set to the automated driving level at level 4. A section S73 is a section including a roundabout.

For example, in a case where the recognition performance of at least one of the sensing area 152L and the sensing area 152R in FIG. 5 deteriorates due to the dirt on the lens of the wide-angle camera of the vehicle 1, the vehicle 1 cannot pass the section S73 (roundabout) by the automated driving at level 4.

In this case, for example, as illustrated in B of FIG. 18, there is a measure-taking method for traveling on a detour S76 by automated driving at low speed and avoiding the section S73.

Furthermore, for example, there is a measure-taking method of passing the section S73 by automated driving at level 3 at which the driver is in a standby state.

For example, there is a measure-taking method in which the vehicle stops at an evacuation place S72A before the section S73, the lens of the wide-angle camera is cleaned, and the vehicle passes the section S73 by automated driving at level 4.

In this case, for example, the timing of presenting the guidance information including the selection menu is controlled such that the cleaning of the lens of the wide-angle camera is performed in the evacuation place S72A before the section S73.

Furthermore, for example, in a case where an immediate response is required, the guidance information including a notification menu with no options may be presented to the driver.

For example, in a case where the recognition performance of the sensing area 152R in FIG. 5 is deteriorated, a problem occurs in the rightward steering or the like performed for turning right, overtaking, avoiding collision with a vehicle ahead, or the like.

On the other hand, for example, when the vehicle is traveling in a section that is straight, has a good field of view, and does not require an immediate lane change or the like, the driver is not required to quickly return to the manual driving. Therefore, in this case, for example, the guidance information including the measure-taking method for returning to the manual driving in the selection menu as an option is presented.

Furthermore, for example, in a case where the vehicle is traveling in an urban area, a mountain area with many corners, or a section with many approaching vehicles from the opposite lane, the driver is required to return to the manual driving quickly. Therefore, in this case, for example, instead of the selection menu, the guidance information including a notification menu such as “An oncoming vehicle is not recognized. Please return to driving promptly.” is presented.

Moreover, for example, in a case where no safe traveling is expected due to deterioration in the recognition performance of the sensing area 152R, the guidance information including a notification menu such as “Due to failure of some environment recognition devices, vehicle will promptly evacuate and stop by MRM.” is presented.

For example, in a case where the recognition performance of the sensing area 155L in FIG. 5 is deteriorated, a vehicle or the like approaching from the left rear cannot be detected.

With regard to this, for example, in a stable straight traveling section such as an expressway, it is not necessary to take an emergency measure. Therefore, the measure-taking method does not need to be presented immediately.

Meanwhile, for example, in a case where the vehicle returns to the original lane after overtaking the preceding vehicle, the inter-vehicle distance with the overtaken vehicle cannot be confirmed. Therefore, for example, before overtaking is performed, the guidance information including, for example, a notification menu for notifying degradation in the recognition performance of the sensing area 155L is presented.

Furthermore, for example, in a case where a sudden lane change is required due to the preceding vehicle stopping or the like, there is a case where the presence of absence of a vehicle approaching from behind cannot be confirmed. Therefore, for example, in a case where the vehicle is traveling in a place where there are many other vehicles such as an urban area, the guidance information including a notification menu that prompts quick return to the manual driving is presented.

For example, in a case where the recognition performance of the sensing area 156L in FIG. 5 is deteriorated, there is no particular problem in traveling on a normal road, and thus the driver does not need to be notified of the deterioration in emergency.

On the other hand, for example, in a case where the vehicle is reversing at the time of parking or the like, detection of the left rear vehicle or the like is hindered. Therefore, for example, in a case where the vehicle 1 enters a parking lot, the guidance information including a notification menu that prompts the driver to monitor the left rear or to return to the manual driving is presented. This guidance information is not necessarily intended only for the vehicle 1 not being able to check the left rear when the vehicle 1 exits the parking lot.

For example, this guidance information is preferably presented when the parking of the vehicle 1 is selected or when the parking is performed. In this way, by presenting the guidance information in advance, the driver is made to recognize in advance that the vehicle 1 cannot confirm the left rear, return to the parking lot early, secure a sufficient time, and then exit the parking lot by the manual driving without relying on the automated driving. That is, an effect of naturally prompting the driver to take the best measure-taking action is expected. Furthermore, as compared with a case where the attention is attracted only by turning on a telltale lamp at the time of starting the vehicle 1 to a defect in the recognition performance of the sensing area 156L, a large difference occurs in memory and action determination by the driver.

Furthermore, for example, a minor defect that does not affect the automated driving and a defect that can be covered by other devices, sensors, and the like are less urgent, and thus it is not always necessary to promptly notify the driver. For example, this includes a case where a light goes off and the vehicle travels continuously using a spare light, or the like.

In this case, for example, the measure-taking method may be presented to the driver in the selection menu as maintenance information after the end of the travel plan.

Furthermore, for example, only defect information may be transmitted to a central management center that performs collection or the like of information regarding each vehicle.

Furthermore, for example, information indicating a specific measure-taking method may be superimposed on a conventional map or the like on which information requiring a measure is superimposed.

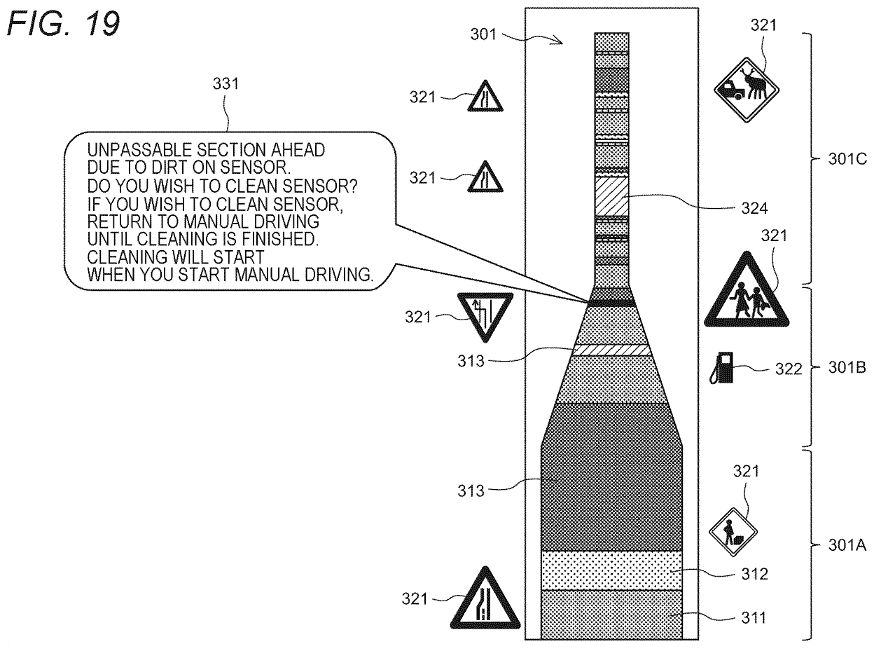

FIG. 19 illustrates an example in which information indicating a specific measure-taking method is superimposed on the guidance information 301 in FIG. 14. Specifically, in the example in FIG. 19, a balloon 331 is superimposed on the guidance information 301 in FIG. 14.

The balloon 331 indicates the measure-taking method for a section (hereinafter, referred to as a target section) pointed by the balloon 331.

Specifically, the balloon indicates that, because the sensor of the vehicle 1 is dirty, the vehicle 1 cannot pass the target section by the automated driving at level 4. Furthermore, cleaning of the sensor is indicated as the measure-taking method. Furthermore, the balloon indicates a caution to be taken in the cleaning of the sensor, that is, the fact that the manual driving is required during the cleaning. Moreover, the balloon indicates that the cleaning of the sensor is started when the manual driving is started.

With this arrangement, the driver can recognize a target section that cannot be passed by the automated driving at level 4 in the current state, and can recognize a specific measure-taking method for passing the target section by the automated driving at level 4. As a result, the driver can pass the target section by the automated driving at level 4 by executing appropriate measures.

Furthermore, for example, the guidance information may include information regarding a risk in a case where the presented measure-taking method is not followed. For example, the driver may be notified by the guidance information that, in a case where the measure-taking method is not followed, the vehicle stops in a vehicle stop prohibited section by the MRM which possibly causes occurrence of a penalty, deduction of points, or the like.

Furthermore, for example, the guidance information does not necessarily need to be dealt with before arrival at the destination, but may include a measure-taking method for an item that needs to be dealt with in the future. For example, the guidance information may include the measure-taking method or information for prompting to take measures regarding maintenance, replacement, inspection, and the like with respect to the deterioration of the in-vehicle device, a notification that is a violation target in a case where a state of not taking measures continues, and the like.

Returning to FIG. 13, in step S204, the travel plan is changed according to the selected measure-taking method, similarly to the processing of step S156 in FIG. 10.

In step S205, the vehicle control system 11 monitors whether the driver has followed the selected measure-taking method, and records the monitoring result.

Specifically, in a case where the measure-taking method that requires a response from the driver is selected, the DMS 30 monitors the action of the driver on the basis of sensor data from the in-vehicle sensor 26, data input to the HMI 31, and the like. Then, on the basis of the monitoring result of the action of the driver, the DMS 30 determines whether or not the driver has performed the action that needs to be responded in the selected measure-taking method. The action that needs to be responded by the driver is, for example, an action of returning to the manual driving, preparing to be able to return to the manual driving, or cleaning the windshield. Furthermore, for example, the action that needs to be responded by the driver is an action for preparing to return to the manual driving in a case where the driver is requested by the vehicle 1 because the visibility is temporarily limited during the cleaning of the windshield.

In a case where the driver performs the action that needs to be responded, the DMS 30 determines that the driver has followed the selected measure-taking method. On the other hand, in a case where the driver has not performed the action that needs to be responded, the DMS 30 determines that the driver has not followed the selected measure-taking method.

The DMS 30 records the information indicating the monitoring result as to whether or not the driver has followed the selected measure-taking method, in the measure-taking history dictionary stored in the storage unit 28. Then, for example, the DMS 30 can learn return action characteristics for various notifications by using the measure-taking history dictionary. With this arrangement, for example, on the basis of observation information of the driver by the DMS 30, the output control unit 112 can estimate at which timing the guidance information or the like is presented to the driver so that the driver can complete the measure taking such as the takeover of driving with a high success probability.

Thereafter, the process proceeds to step S206.

On the other hand, in a case where it is determined in step S202 that the change of the travel plan is not necessary, the processing of steps S203 to S205 is skipped, and the processing proceeds to step S206.

In step S206, the action planning unit 62 determines whether or not the vehicle has arrived at the destination. In a case where it is determined that the vehicle has not arrived at the destination, the processing returns to step S202.

Thereafter, until it is determined in step S206 that the vehicle has arrived at the destination, the processing of steps S202 to S206 are repeatedly executed.

On the other hand, in a case where it is determined in step S206 that the vehicle has arrived at the destination, the travel control processing ends.

As described above, because a measure-taking method is presented to the driver, the driver can appropriately select and take measures with a desired measure-taking method. Furthermore, by making a menu of specific measure-taking methods and presenting the menu to the driver, the driver can more reliably recognize the situation of each section and the content to be dealt with as compared with a case where a simple operation using a button or the like is performed. Furthermore, the driver can accurately know various traveling environmental conditions that change with the lapse of time such as the environment and equipment of the vehicle 1, and the relationship between the driver oneself and the vehicle control system 1 with respect to the vehicle 1 that performs the automated driving, and can appropriately take necessary measures.

Moreover, as described above, the mechanism of presenting the measure-taking method to the driver every time a situation to be dealt with occurs is close to a process of predicting in advance a risk that possibly occurs before departure or the like in a case where the driver performs the manual driving and taking measures in advance. Therefore, the driver can unconsciously recognize the situation, the problem, and the like of the future travel plan. With this arrangement, for example, when the vehicle 1 passes a section being a target of taking measures, there is a high possibility that the driver can quickly and accurately recognize the situation of the section and appropriately take measures.

Furthermore, for example, by presenting the measure-taking method for an occurring situation or a predicted situation at specific and appropriate timing, the driver can accurately recognize whether the situation is within or outside the range of the ODD of the automated driving. With this arrangement, for example, handover from the automated driving to the manual driving is performed safely and seamlessly. Furthermore, the automated driving and the manual driving can be appropriately complemented with each other, and the convenience of the vehicle 1 is improved.

Returning to FIG. 9, in step S104, the vehicle 1 ends the traveling.

In step S105, the vehicle control system 11 executes post-travel processing and the automated driving control processing ends.

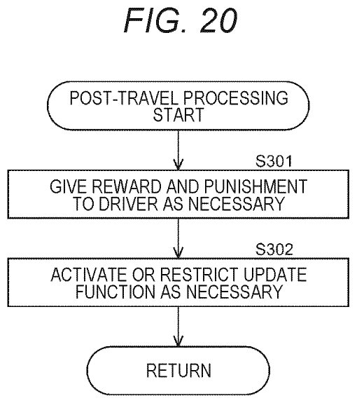

Here, details of the post-travel processing will be described with reference to a flowchart in FIG. 20.

In step S301, the vehicle control system 11 gives reward and punishment to the driver as necessary.

For example, the reward and punishment granting unit 113 calculates a ratio between a case where the driver follows the selected measure-taking method and a case where the driver does not follow the selected measure-taking method within the latest predetermined period on the basis of the measure-taking history dictionary stored in the storage unit 28.

For example, in a case where the ratio of a case where the driver does not follow the selected measure-taking method is equal to or more than a predetermined threshold value, the reward and punishment granting unit 113 gives a penalty to the driver.

The content of the penalty given to the driver is, for example, to lower the convenience of the driver for the automated driving of the vehicle 1 within a range in which the safety of traveling of the vehicle 1 is guaranteed.

For example, use of the automated driving is restricted. Specifically, for example, the automated driving is disabled for a predetermined period. For example, the automated driving is disabled until the driver takes a necessary measure (for example, until the windshield is cleaned).

For example, for a predetermined period, a measure-taking method that requires a response from the driver is excluded from the options in the selection menu. With this arrangement, the options of the measure-taking methods are narrowed, and the convenience of the driver is lowered.

For example, after the driver performs the manual driving, a return period after which the automated driving function can be used again is extended. That is, because it is determined that the appropriate return of the driver cannot be expected, the use of the automated driving function is not permitted even under the condition where the automated driving function can be provided, and thus, the excessive dependence of the driver on the automated driving can be suppressed and the driver can be prompted to take an appropriate measure.

For example, a path is set while a section that possibly requires a response from the driver is excluded. With this arrangement, for example, there is a high possibility that a section in which the vehicle travels at low speed by the automated driving is selected in order to ensure the safety of the automated driving. As a result, the necessary time and the moving distance become long, which becomes a penalty with a feeling of disadvantage for a driver who wants to arrive at the destination quickly.

On the other hand, for example, in a case where the ratio of a case where the driver follows the selected measure-taking method is equal to or more than a predetermined threshold value, the reward and punishment granting unit 113 gives an incentive to the driver.

The content of the incentive to be granted to the driver is not particularly limited as long as the driver can feel the merit. For example, a point is granted, a penalty imposed on the driver at present is reduced, or a target period of the penalty is shortened.

Here, if the driver does not follow the selected measure-taking method, the expected function or effect is not realized by presenting the selection menu. As a result, the use cycle of the selection menu expected by the driver does not occur.

Furthermore, if the driver does not follow the measure-taking method or deceives the system during use, inconvenience occurs in the travel plan created on the assumption that the driver follows the measure-taking method. For example, in a case where a measure-taking method of returning to the manual driving after passing the entrance of a detour is selected, if the driver does not return to the manual driving, the path cannot be changed to the detour, and there is a risk that an emergency stop or the like occurs.

Moreover, if the processing in which the vehicle control system 11 automatically executes the measure taking on the safe side is repeated due to the driver not following the selected measure-taking method, there is a risk that the driver becomes insensitive. For example, there is a risk that, even if the driver does not follow the selected measure-taking method, the driver falsely believes that the automated driving is safely continued. With this arrangement, there is a possibility that the driver excessively depends on the automated driving function. Furthermore, the driver becomes less conscious of following the measure-taking method, and there is a risk that a function of displaying the menu of the measure-taking method becomes ineffective.

Furthermore, for example, if the driver makes a careless and incomplete selection without understanding the presented measure-taking method, the driver cannot sufficiently recognize a situation that should be recognized at the time of making the selection. Therefore, for example, in a case where the driver tries to return to the manual driving, the determination is delayed, or the driver performs excessive steering without exerting cognitive suppression on the reflective steering response, which possibly induces an accident.

Here, considering the action of a person separately as a reflex action and a conscious action, in a case where a strong stimulus such as danger is received, an action command only for avoiding the factor is issued to the body. If this avoidance action instruction is not accompanied by action suppression, an excessive avoidance action is executed. Therefore, for example, if the monitoring or the like of the awakening state of the driver or the preliminary situation is neglected, there is a risk that the driver cannot correctly recognize and determine the influence of the avoidance motion on the action of the vehicle and performs excessive steering wheel operation.

With regard to this, by recognizing in advance the influence of the measure-taking method and a result of the measure taking by the driver and giving reward and punishment on the basis of a result of monitoring whether or not the driver follows the result, the motivation is given to the driver to follow the measure-taking method. As a result, the probability that the driver follows the measure-taking method increases, and the safety and convenience of the automated driving are improved.

These determinations can be made only when there is information for the driver to recognize the necessity of following the selected measure-taking method, including monitoring of the driver and checking whether or not the driver has followed the selected measure-taking method.

Conventionally, as illustrated in FIG. 14 described above, the risk related information on the course and the information regarding the automated driving level are presented, or only the presence or absence of equipment failure of the vehicle is presented by a telltale or the like. On the other hand, a measure-taking method based on continuously changing travel environment conditions or user preferences is not presented to the driver.

For example, when a notification by the telltale is made every time the dirt on the windshield is detected, it is assumed that the driver frequently performs the cleaning in response to the notification. Meanwhile, even if the presence or absence of the notification by telltale changes depending on a time zone, a season, or the like for the same type of dirt, it is difficult for the driver to recognize the ODD boundary condition under which the vehicle 1 can safely execute the automated driving. That is, if the guidance information in which the ODD boundary condition or the like is replaced with an explicit measure-taking method is not presented, the driver is forced to make a decision and take an action only on the basis of subjective information that can be known at that time.

On the other hand, in the present technology, as described above, by presenting the guidance information including the selection menu and the like to the driver, information necessary for taking an appropriate measure is presented. In other words, it can be said that the guidance information including the selection menu is a mechanism that macroscopically determines the ODD boundary condition, and the travel environment condition based on the diagnostic information of the devices of the vehicle 1, the road environment information, the state of the driver, and the like, and inputs the information to the driver through the HMI 31.

In step S302, the function update control unit 114 activates or restricts the update function as necessary. That is, the function update control unit 114 activates or restricts the update function as necessary mainly in a case where the OTA or the service center performs update processing of a control processing program of the vehicle. For example, the function update control unit 114 analyzes a state of usage of the update function of the driver on the basis of the measure-taking history dictionary or the like stored in the storage unit 28. The function update control unit 114 activates or restricts the update function as necessary on the basis of the analysis result.

Thereafter, the post-travel processing ends.

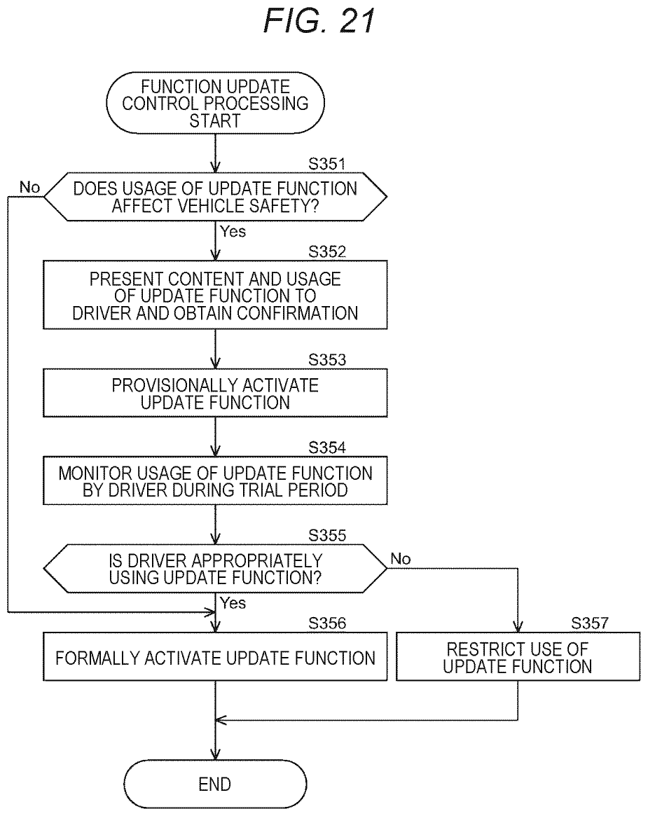

Here, details of the function update control processing including the processing of step S302 will be described with reference to a flowchart in FIG. 21.

This processing is started, for example, when the vehicle 1 receives an update program, transmitted by the OTA, for updating the function of the vehicle 1.

In step S351, the function update control unit 114 determines whether or not a usage of the update function affects the safety of the vehicle 1.

For example, in a case where the update function is a function used by the driver and an incorrect usage affects the safety of the vehicle 1, the function update control unit 114 determines that the usage of the update function affects the safety of the vehicle 1, and the processing proceeds to step S352.

Note that the usage of the update function includes, for example, a procedure of use, a condition of use, and the like.

For example, in a case where the update function involves a change in the application range of the automated driving due to update of the LUT, update of the control matrix, or the like, it is determined that the usage of the update function affects the safety of the vehicle 1.

In step S352, the vehicle control system 11 presents the content and the usage of the update function to the driver to obtain confirmation.

For example, the display unit 131 presents the content and the usage of the update function under the control of the output control unit 112.

In response to this, the driver checks the content and the usage of the presented update function, and then inputs the confirmation of the content and the usage of the update function to the HMI 31.

In response to this, the HMI 31 notifies the function update control unit 114 that the driver has confirmed the usage of the update function.

In step S353, the function update control unit 114 provisionally activates the update function. For example, the function update control unit 114 installs the update program in the storage unit 28 and activates the update function in a state where the program can be restored to the program before the update. With this arrangement, for example, the update function is provisionally (temporarily) enabled during a predetermined trial period.

In step S354, the DMS 30 monitors the state of usage of the update function of the driver during the trial period.

Note that, for example, in a case where the application range of the automated driving is changed by the update function, the usage including the change may be repeatedly presented by the guidance information such as the selection menu during the trial period. With this arrangement, for example, the driver can accurately understand the boundary of the travel environment condition to which the automated driving is applied after the change, and can prevent overconfidence in the automated driving.

For example, in a case where at least one of the content and the usage of the update function is difficult, the guidance information for checking a degree of understanding of the update function may be repeatedly presented at the appropriate timing. With this arrangement, the driver can correctly understand and appropriately use the update function.

Furthermore, for example, the HMI 31 may instruct the usage of the update function by a conversational instruction converted into a natural language by using an AI technology or the like. In this case, for example, teaching of such as switching conditions between the automated driving and the manual driving is executed by the conversation type instruction.

In step S355, the DMS 30 determines whether or not the driver is properly using the update function on the basis of the result of the processing in step S354. For example, in a case where the driver is using the update function in an accurate procedure under an appropriate condition, the DMS 30 determines that the driver is properly using the update function, and the processing proceeds to step S356.

On the other hand, in step S351, in a case where the update function is a function not used by the driver or an incorrect usage does not affect the safety of the vehicle 1, the function update control unit 114 determines that the usage of the update function does not affect the safety of the vehicle 1. Then, the processing from step S352 to step S355 is skipped, and the processing proceeds to step S356.

For example, it is determined that the update function such as the improvement in the fuel consumption and the improvement of the vulnerability of the communication security does not affect the safety of the vehicle 1 by the usage performed by the driver. However, it is not necessarily limited to the above case, in a case where, in the function of improvement in the fuel consumption, the driver is not satisfied with the acceleration/deceleration control by the system and leads to repeated use of acceleration/deceleration intervention or the like that causes increase in the risk.

In step S356, the function update control unit 114 formally activates the update function. That is, the update function is formally and permanently enabled.

Thereafter, the function update control processing ends. On the other hand, in step S355, for example, in a case where the driver is not using the update function under the appropriate condition, the DMS 30 determines that the driver is not properly using the update function, and the processing proceeds to step S357.

In step S357, the function update control unit 114 restricts the use of the update function.

For example, the function update control unit 114 deletes the update program or the access lock, and returns the program of the function to the state before the update.

Alternatively, for example, the function update control unit 114 starts over the processing from the processing of step S352. That is, the trial period of the update function is performed again.

Thereafter, the function update control processing ends.

Here, unlike a personal computer, a smartphone, or the like, in the vehicle, when a failure occurs in the update function of vehicle control or when the usage of the update function is incorrect, the influence on the surroundings is large.

Meanwhile, even if the driver is notified of the information regarding the function updated by the OTA, the driver cannot always correctly understand and use the update function. For example, even if a manual for the update function is provided, the driver does not necessarily read the manual or correctly understand the content of the manual.

For example, in the automated driving at level 4 or lower complemented and used by the driver and the vehicle control system 11, when the application range of the automated driving changes by to the OTA, there are cases where the condition and timing for the driver to take over from the automated driving to the manual driving changes. Therefore, there is a risk that the vehicle control system 11 is not handed over to the manual driving under expected conditions and timings, or a measure for avoiding danger is not executed, so that an emergency stop due to the MRM or the like is induced, or an accident occurs.

On the other hand, as described above, by activating the update function formally after confirming that the driver correctly understands the usage of the update function and the update function is properly used, the update function is reliably and properly used.

Furthermore, because the usage and the like of the update function are appropriately presented, a degree of understanding of the driver on the update function is improved. Moreover, the driver can learn the usage of the update function through actual experience. With this arrangement, the application ability of the driver to the update function is improved, and the driver can expand the application range of the update function.

However, even if the driver carefully uses the update function immediately after the update, there are cases where the driver becomes careless in performing the usage as the driver gets used to the update function. Therefore, even after the update function is formally activated, the update function may be configured to enable to be restored as necessary.

Furthermore, for example, the update function may be enabled in stages according to the degree of understanding of the driver.

Moreover, for example, there is a case where a plurality of users shares the same vehicle 1 by using a rental car service, car sharing, sharing between family members, or the like. In this case, the degree of understanding of the update function differs for each user. With regard to this, for example, the function update control unit 114 may, for example, enable or restrict the update function for each user.

Furthermore, for example, a case is assumed in which, in a case where the driver inappropriately uses the update function after formally activating the update function, the activation of the update function needs to be canceled.

For example, a case is assumed in which, in a case where the driver is confirmed to be drinking during the automated driving at level 4 in the actual use environment, there is a possibility that the driver is not punished under the current law. However, this corresponds to a case where the automated driving function is excessively relied on and abused, and should not be allowed, and is one of the cases where it is desirable to externally disable the update function.

Furthermore, in the short term, a case is assumed in which, although the driver carefully uses the update function because the driver is doubtful about the update function, a sense of comfort is increased due to long-term use, and excessive dependence on the update function gradually progresses. Then, in a case where dangerous use of the update function progresses due to excessive dependence, the update function may be invalidated.

What is important in function update by the OTA or the like is that a change in a target range of system control (for example, the ODD boundary) associated with the function update is presented as the guidance information in a format that can be intuitively determined by the driver, and the update function is appropriately used by using the information.

With regard to this, simply describing the update function in a manual or explaining the update function at a car dealer causes the information to be transmitted to become temporary and unilaterally. Furthermore, these are actively involved by the experience in the field and do not experience the change of the boundary condition or the required measure, and thus are different from the instruction for the update function.

On the other hand, by presenting the guidance information such as the selection menu at the introduction stage of the update function, an appropriate instruction and a training period for the update function are provided to the driver. With this arrangement, the update function is formally activated at the stage of having the correct usage learned, and full operation can be started. Note that, after the formal activation is performed, the guidance information may be simplified.

Conventionally, the boundary of the ODD is discontinuously set on the assumption that the state of the automated driving system is fixed and the absolute factor of the handover to the manual driving is on the road side. Therefore, as information required for determination of the handover to the manual driving of the driver, the information is uniquely presented by a road caution sign or the like that intuitively and explicitly schematically illustrates danger and influence.

On the other hand, the present technology is a technology of replacing an explicitly invisible boundary of the ODD that can vary due to a combination of multidimensional variation factors with explicit information useful for user determination and presenting the information. Furthermore, factors that possibly cause the ODD boundary to vary include update and change of control software and control variables by the OTA. Then, because there is a possibility that only presentation of information does not lead to maintenance and improvement of expected driver involvement, safe use of the automated driving function is promoted by combining the reward and punishment function for enabling the update function in which the boundary of the ODD varies.

### 3. Modification

Hereinafter, modifications of the above-described embodiments of the present technology will be described.

For example, in a case of evacuating from emergency situations such as earthquakes or tsunamis, the vehicle 1 does not necessarily follow the automated driving level and the constraint condition derived by the control matrix, or the user preference. For example, the vehicle 1 may prioritize a measure-taking method that allows the vehicle 1 to quickly pass each section even if the vehicle 1 runs a risk.

For example, a representative example in which the situation dynamically changes during traveling of the vehicle 1 includes dirt on the detection windows of the sensors. The dirt on the detection windows of the sensors causes time degradation of the detection performance of the sensors.

With regard to this, wiping cleaning of the detection window is provided as effective means for recovering the detection performance of the sensors. However, in the conventional wiper type cleaning method, the detection performance of the sensors deteriorates during the cleaning operation. Furthermore, for example, when the wiper is operated in a state where the mud or the like is semi-dried, the mud or the like temporarily extends and spreads, and the detection performance further deteriorates until the cleaning is completed.

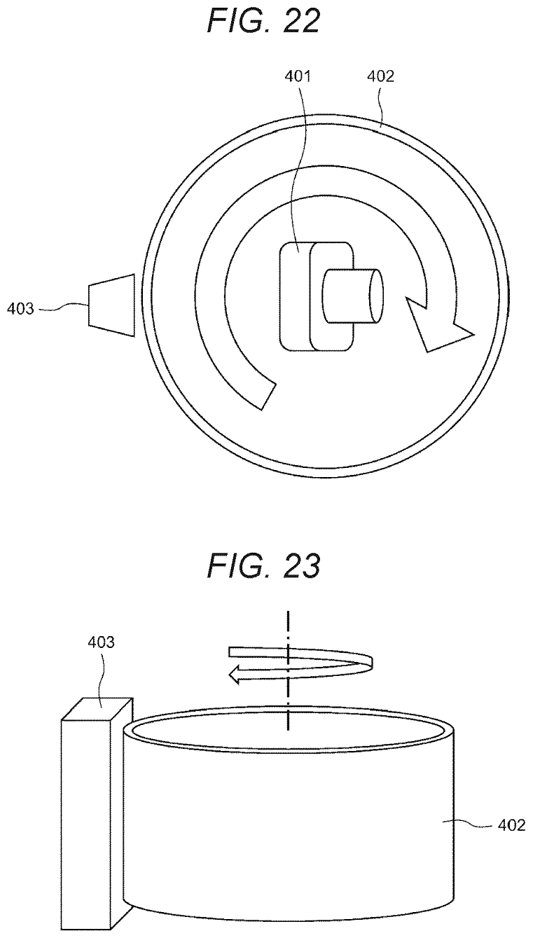

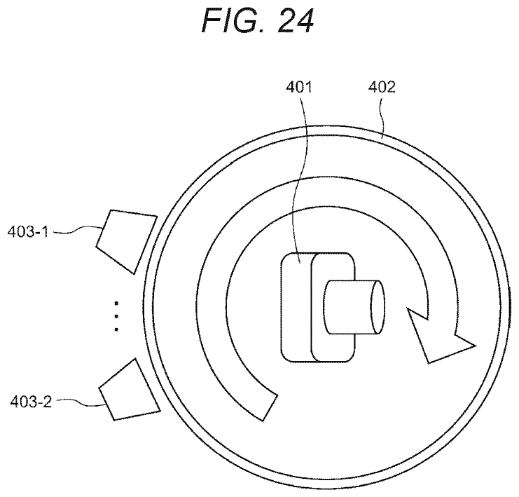

On the other hand, for example, as illustrated in FIGS. 22 and 23, a sensor 401 such as a camera or LiDAR which is a small environment recognition device may be protected by a hollow cylindrical rotation window 402.

Specifically, the sensor 401 is disposed in the rotation window 402. A cleaning stage 403 is disposed on the side opposite to the sensing direction of the sensor 401 on the outer periphery of the rotation window 402.

For example, a reference light source (not illustrated) such as an LED is used to index the dirt of the rotation window 402 at the viewing angle of the sensor 401 by a dirt evaluation detection algorithm. In a case where the dirt on the rotation window 402 at the viewing angle of the sensor 401 exceeds the allowable level at each point of the planned path, the rotation window 402 rotates in the direction of the arrow so that the dirt on the rotation window 402 at the viewing angle of the sensor 401 becomes equal to or less than the allowable level. Furthermore, in the cleaning stage 403, the rotation window 402 is cleaned.

With this arrangement, the sensor 401 is protected by the rotation window 402, and the rotation window 402 is kept clean at the viewing angle of the sensor 401. Furthermore, the detection performance of the sensor 401 does not deteriorate during cleaning of the rotation window 402.

Note that, for example, as illustrated in FIG. 24, a plurality of cleaning stages 403-1 to 403-n may be arranged along the outer periphery of the rotation window 402 for every stage of cleaning. The stage of cleaning is divided into, for example, rough washing, washing, rinsing, drying, and the like.

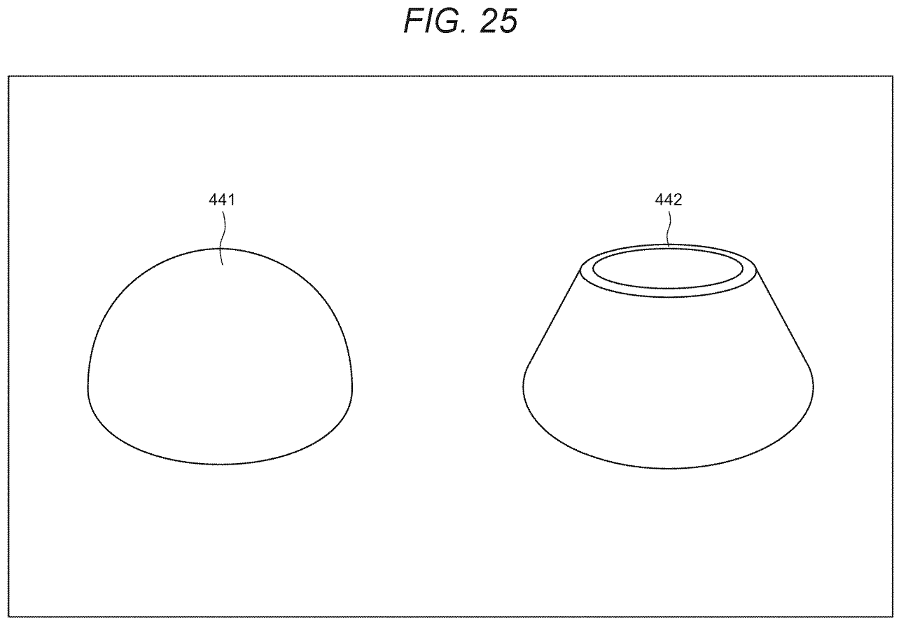

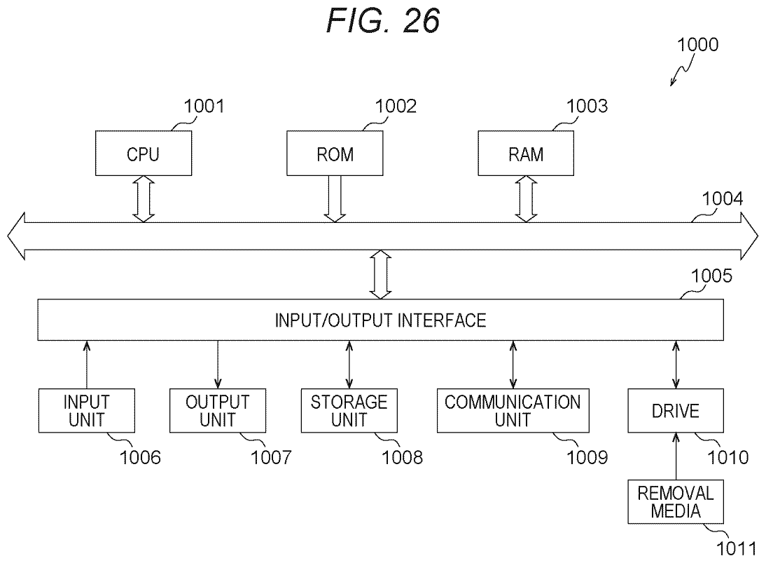

Note that the rotation window may not necessarily have a hollow cylindrical shape. For example, as illustrated in FIG. 25, a hollow hemispherical rotation window 441 or a hollow truncated conical rotation window 442 may be used instead of the rotation window 402.

Note that, as an example of the temporal change of the equipment of the vehicle 1 that causes the change in the applicable automated driving level, in addition to the dirt on the windows of the sensors described above, tire wear, insufficient air pressure of tires during high-speed traveling, running out of lamp, sonar failure, and the like are assumed.

On the basis of the multidimensional elements continuously changing including the time degradation of the equipment of the vehicle 1 described above, it is determined whether or not the applicable automated driving level, that is, the travel environment condition is included in the range of the ODD of each automated driving level. Therefore, instead of simply presenting the binary determination as to whether or not the automated driving can be used, means for accurately transmitting information determined by the continuously changing multidimensional elements and correct behavior determination of the driver based on the transmission content are essential for the safe vehicle operation.

Furthermore, in terms of ergonomics, it is essential that a mechanism for preventing the driver from neglecting the instruction and inappropriately using the automated driving function is combined in the operation. In addition, a criterion for determining whether or not the driver has taken a measure expected by the vehicle control system 11 is required. With regard to this, the guidance information described above becomes the information that enables the driver to recognize the boundary of the ODD on the basis of the request of the vehicle control system 11 and to recognize that the driving is safely taken over.

The present technology can also be applied to a mobile object that performs the automated driving other than the vehicle and in which the automated driving level is set and a response from the driver is required in some cases.

The present technology can also be applied to a case where a user other than the driver uses the vehicle 1. For example, the present technology can also be applied to a case where the guidance information is presented to a user other than the driver or update of a function used by a user other than the driver is controlled.

### 4. Others

### <Configuration Example of Computer>

The above-described series of processing can be executed by hardware or software. In a case where the series of processing is executed by software, a program constituting the software is installed in a computer. Here, examples of the computer include a computer incorporated in dedicated hardware, and for example, a general-purpose personal computer that can execute various functions by installing various programs.

FIG. 22 is a block diagram illustrating a configuration example of hardware of a computer that executes the above-described series of processing with a program.

In a computer 1000, a central processing unit (CPU) 1001, a read only memory (ROM) 1002, and a random access memory (RAM) 1003 are interconnected via a bus 1004.

Moreover, an input/output interface 1005 is connected to the bus 1004. To the input/output interface 1005, an input unit 1006, an output unit 1007, a storage unit 1008, a communication unit 1009, and a drive 1010 are connected.

The input unit 1006 includes an input switch, a button, a microphone, an imaging element and the like. The output unit 1007 includes a display, a speaker, and the like. The storage unit 1008 includes a hard disk, a non-volatile memory, and the like. The communication unit 1009 includes a network interface and the like. The drive 1010 drives a removable medium 1011 such as a magnetic disk, an optical disc, a magneto-optical disk, or a semiconductor memory.

In the computer 1000 configured as described above, the series of processing described above is performed, for example, by the CPU 1001 loading a program stored in the storage unit 1008 into the RAM 1003 via the input/output interface 1005 and the bus 1004, and executing the program.

The program executed by the computer 1000 (CPU 1001) can be provided, for example, by being recorded in the removable medium 1011 as a package medium and the like. Furthermore, the program can be provided via a wired or wireless transmission medium such as a local area network, the Internet, or digital satellite broadcasting.

In the computer 1000, the program can be installed in the storage unit 1008 via the input/output interface 1005 by mounting the removable medium 1011 on the drive 1010. Furthermore, the program can be received by the communication unit 1009 via a wired or wireless transmission medium and installed in the storage unit 1008. In addition, the program can be preinstalled in the ROM 1002 and the storage unit 1008.

Note that the program executed by the computer may be a program that executes processing in time series in the order described in the present description, or a program that executes processing in parallel or at a necessary timing such as when a call is made.

Furthermore, in the present description, a system means assembly of a plurality of components (devices, modules (parts), and the like) and it does not matter whether or not all the components are in the same housing. Therefore, a plurality of devices housed in separate housings and connected via a network and one device in which a plurality of modules is housed in one housing are both systems.

Moreover, the embodiment of the present technology is not limited to the above-described embodiment, and various modifications can be made without departing from the gist of the present technology.

For example, the present technology can have a configuration of cloud computing in which one function is shared and executed by a plurality of devices via a network.

Furthermore, in the present description, an example has been described in which the driver who gets on the vehicle mainly intervenes with the vehicle control system 11 alone. On the other hand, in the actual automated driving, it is expected that the ODD is set in various forms such as a remote operator, a leading vehicle, platooning traveling, and a concierge service for performing route planning. Then, it is expected that it is necessary to share and grasp the ODD boundary condition.

With regard to this, the present technology may be operated and executed in combination with various operation modes such as cooperation and recognition complement by communication with surrounding vehicles, a remote operator, a concierge service, a guidance leading vehicle providing service, and a platooning service.

Furthermore, each step described in the flowcharts described above may be executed by one device, or can be performed by a plurality of devices in a shared manner.

Moreover, in a case where a plurality of pieces of processing is included in one step, the plurality of pieces of processing included in the one step can be executed by one device or shared and executed by the plurality of the devices.

### <Combination Examples of Configurations>

The present technology can have the following configurations.

(1)

A mobile object control device including:
a travel environment condition acquisition unit that acquires a travel environment condition used to set an automated driving level of a mobile object;
an action planning unit that creates a travel plan including a path and the automated driving level applied to each section on the path on the basis of the travel environment condition that has been acquired, and creates a measure-taking method for an automated driving restricted section being a section in which automated driving is restricted; and
an output control unit that controls presentation of guidance information including the measure-taking method to a user, in which
the action planning unit sets or changes the travel plan according to the measure-taking method selected by the user.
   (2)

The mobile object control device according to (1), further including
a monitoring unit that monitors whether or not the user follows the measure-taking method that has been selected.
   (3)

The mobile object control device according to (2), in which
the monitoring unit monitors whether or not the user has performed a necessary response in a case where the measure-taking method that requires a response by the user is selected.
   (4)

The mobile object control device according to (2) or (3), further including
a reward and punishment granting unit that grants at least one of a penalty or an incentive to the user on the basis of a result of monitoring whether or not the user has followed the measure-taking method that has been selected.
   (5)

The mobile object control device according to (4), in which
the reward and punishment granting unit lowers convenience of the user for automated driving of the mobile object as the penalty.
   (6)

The mobile object control device according to (2) or (3), further including
a function update control unit that controls update of a function of the mobile object, in which
the monitoring unit monitors a state of usage by the user during a trial period of an update function which is a function to be updated, and
the function update control unit formally enables the update function or restricts use of the update function on the basis of a monitoring result of the state of usage of the update function.
   (7)

The mobile object control device according to (6), in which
the monitoring unit monitors the state of usage of the update function by the user, the usage of the update function affecting safety of the mobile object.
   (8)

The mobile object control device according to (6) or (7), in which
the update function is a function updated by Over The Air (OTA).
   (9)

The mobile object control device according to (6) or (7), in which
the output control unit repeatedly presents the guidance information including a usage of the update function to the user during the trial period.
   (10)

The mobile object control device according to any one of (1) to (3), in which
the guidance information includes a plurality of the measure-taking methods.
   (11)

The mobile object control device according to (10), in which
the guidance information includes a selection menu in which a plurality of the measure-taking methods is aligned in a selectable manner.
   (12)

The mobile object control device according to (11), in which
the selection menu includes a plurality of the measure-taking methods aligned in a priority order based on a preference preset by the user.
   (13)

The mobile object control device according to any one of (1) to (3), in which
the output control unit controls a timing at which the guidance information including the measure-taking method is presented to the user on the basis of a timing at which the user is predicted to pass the automated driving restricted section affected by the measure-taking method.
   (14)

The mobile object control device according to any one of (1) to (3), in which
the travel plan further includes a constraint condition configured to execute automated driving of automated driving level to be applied.
   (15)

The mobile object control device according to any one of (1) to (3), in which
the mobile object is a vehicle, and
the user is a driver of the vehicle.
   (16)

The mobile object control device according to (15), in which
the automated driving restricted section is a section in which automated driving at level 4 cannot be executed without a constraint condition.
   (17)

The mobile object control device according to (16), in which
the constraint condition is a constraint condition regarding at least one of a moving speed and an inter-vehicle distance of the vehicle.
   (18)

The mobile object control device according to any one of (15) to (17), in which
the action planning unit sets the automated driving level to be applied to each section on the path on the basis of the travel environment condition that has been acquired, by using information used to derive the automated driving level applicable to the vehicle with respect to a pattern of the travel environment condition that is not defined in an operational design domain.
   (19)

A mobile object control method including:
acquiring a travel environment condition used to set an automated driving level of a mobile object;
creating a travel plan including a path and the automated driving level applied to each section on the path on the basis of the travel environment condition that has been acquired;
creating a measure-taking method for an automated driving restricted section being a section in which automated driving is restricted;
controlling presentation of guidance information including the measure-taking method to a user; and
changing the travel plan according to the measure-taking method selected by the user.
   (20)

A mobile object including:
a travel environment condition acquisition unit that acquires a travel environment condition used to set an automated driving level;
an action planning unit that creates a travel plan including a path and the automated driving level applied to each section on the path on the basis of the travel environment condition that has been acquired, and creates a measure-taking method for an automated driving restricted section being a section in which automated driving is restricted; and
an output unit that presents guidance information including the measure-taking method to a user, in which
the action planning unit sets or changes the travel plan according to the measure-taking method selected by the user.

Note that the effects described in the present description are merely examples and are not limited, and other effects may be provided.

### REFERENCE SIGNS LIST

1 Vehicle
11 Vehicle control system
21 Vehicle control ECU
25 External recognition sensor
30 DMS
31 HMI
32 Vehicle control unit
101 Information processing unit
111 Travel environment information acquisition unit
112 Output control unit
113 Reward and punishment granting unit
114 Function update control unit
121 Output unit
131 Display unit
132 Audio output unit
133 Haptics device

1. A mobile object control device comprising:
a travel environment condition acquisition unit that acquires a travel environment condition used to set an automated driving level of a mobile object;
an action planning unit that creates a travel plan including a path and the automated driving level applied to each section on the path on a basis of the travel environment condition that has been acquired, and creates a measure-taking method for an automated driving restricted section being a section in which automated driving is restricted; and
an output control unit that controls presentation of guidance information including the measure-taking method to a user, wherein
the action planning unit sets or changes the travel plan according to the measure-taking method selected by the user.

2. The mobile object control device according to claim 1, further comprising
a monitoring unit that monitors whether or not the user follows the measure-taking method that has been selected.

3. The mobile object control device according to claim 2, wherein
the monitoring unit monitors whether or not the user has performed a necessary response in a case where the measure-taking method that requires a response by the user is selected.

4. The mobile object control device according to claim 2, further comprising
a reward and punishment granting unit that grants at least one of a penalty or an incentive to the user on a basis of a result of monitoring whether or not the user has followed the measure-taking method that has been selected.

5. The mobile object control device according to claim 4, wherein
the reward and punishment granting unit lowers convenience of the user for automated driving of the mobile object as the penalty.

6. The mobile object control device according to claim 2, further comprising
a function update control unit that controls update of a function of the mobile object, wherein
the monitoring unit monitors a state of usage by the user during a trial period of an update function which is a function to be updated, and
the function update control unit formally enables the update function or restricts use of the update function on a basis of a monitoring result of the state of usage of the update function.

7. The mobile object control device according to claim 6, wherein
the monitoring unit monitors the state of usage of the update function by the user, the usage of the update function affecting safety of the mobile object.

8. The mobile object control device according to claim 7, wherein
the mobile object is a vehicle, and
the update function is a function of deriving the automated driving level applicable to the vehicle with respect to a pattern of the travel environment condition that is not defined in an operational design domain.

9. The mobile object control device according to claim 6, wherein
the update function is a function updated by Over The Air (OTA).

10. The mobile object control device according to claim 1, wherein
the guidance information includes a plurality of the measure-taking methods.

11. The mobile object control device according to claim 10, wherein
the guidance information includes a selection menu in which a plurality of the measure-taking methods is aligned in a selectable manner.

12. The mobile object control device according to claim 11, wherein
the selection menu includes a plurality of the measure-taking methods aligned in a priority order based on a preference preset by the user.

13. The mobile object control device according to claim 1, wherein
the output control unit controls a timing at which the guidance information including the measure-taking method is presented to the user on a basis of a timing at which the user is predicted to pass the automated driving restricted section affected by the measure-taking method.

14. The mobile object control device according to claim 1, wherein
the travel plan further includes a constraint condition configured to execute automated driving of automated driving level to be applied.

15. The mobile object control device according to claim 1, wherein
the mobile object is a vehicle, and
the user is a driver of the vehicle.

16. The mobile object control device according to claim 15, wherein
the automated driving restricted section is a section in which automated driving at level 4 cannot be executed without a constraint condition.

17. The mobile object control device according to claim 16, wherein
the constraint condition is a constraint condition regarding at least one of a moving speed and an inter-vehicle distance of the vehicle.

18. The mobile object control device according to claim 15, wherein
the action planning unit sets the automated driving level to be applied to each section on the path on a basis of the travel environment condition that has been acquired, by using software including a function of deriving the automated driving level applicable to the vehicle with respect to a pattern of the travel environment condition that is not defined in an operation design domain.

19. A mobile object control method comprising:
acquiring a travel environment condition used to set an automated driving level of a mobile object;
creating a travel plan including a path and the automated driving level applied to each section on the path on a basis of the travel environment condition that has been acquired;
creating a measure-taking method for an automated driving restricted section being a section in which automated driving is restricted;
controlling presentation of guidance information including the measure-taking method to a user; and
changing the travel plan according to the measure-taking method selected by the user.

20. A mobile object comprising:
a travel environment condition acquisition unit that acquires a travel environment condition used to set an automated driving level;
an action planning unit that creates a travel plan including a path and the automated driving level applied to each section on the path on a basis of the travel environment condition that has been acquired, and creates a measure-taking method for an automated driving restricted section being a section in which automated driving is restricted; and
an output unit that presents guidance information including the measure-taking method to a user, wherein
the action planning unit sets or changes the travel plan according to the measure-taking method selected by the user.
